(19) United States
(12) Patent Application Publication
(10) Pub. No.: US 2010/0020126 A1
(43) Pub. Date: Jan. 28, 2010

(54) LIQUID SUPPLY DEVICE AND LIQUID EJECTING APPARATUS

(75) Inventor: Masaru TAKAHASHI, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/507,681

(22) Filed: Jul. 22, 2009

(30) Foreign Application Priority Data
Jul. 23, 2008 (JP) 2008-190197
Jul. 23, 2008 (JP) 2008-190198

(51) Int. Cl. B41J 2/165

(52) U.S. Cl. 347/30

(57) ABSTRACT

A liquid supply device is provided in a liquid ejecting apparatus which includes a liquid ejecting head and a cleaning section. The liquid supply device includes a liquid supply section that has a pump in the path of a liquid supply flow channel for interconnecting a liquid supply source and the liquid ejecting head and a pair of unidirectional valves on upstream and downstream sides of the pump. The liquid supply section supplies the liquid to the downstream side with a suction drive that suctions the liquid from the liquid supply source and a discharge drive that discharges the suctioned liquid. A valve section in the path of the liquid supply flow channel on the downstream side is maintained in a valve-closed state by the suction force applied to an ejection port, and is opened by a liquid supply pressure generated by the discharge drive in the valve-closed state.

### CROSS REFERENCES TO RELATED APPLICATIONS

The present invention contains subject matter related to Japanese Patent Application No. 2008-190197 filed in the Japanese Patent Office on Jul. 23, 2008, and Japanese Patent Application No. 2008-190198 filed in the Japanese Patent Office on Jul. 23, 2008, the entire contents of which are incorporated herein by reference.

### BACKGROUND

1. Technical Field

The present invention relates to a liquid supply device and a liquid ejecting apparatus. The liquid supply device is provided in the liquid ejecting apparatus which includes a liquid ejecting head having an ejection port for ejecting liquid and a cleaning section for compulsorily discharging the liquid from the ejection port by applying the ejecting port with a negative pressure. The liquid supply device includes a liquid supply section that has a pump provided in a part of a liquid supply flow channel, a first unidirectional valve provided on an upstream side of the pump, and a second unidirectional valve provided on a downstream side of the pump.

2. Related Art

In the past, ink jet type printers as liquid ejecting apparatuses are configured to eject ink droplets as liquid onto a target (paper and the like) from a printing head, thereby printing letters, images, and the like. In addition, these types of printers are equipped with an ink cartridge (a liquid container) as an ink supply source for supplying ink to the printing head. Examples of known ink supply methods for supplying ink from an ink cartridge to a printing head include a method of using a water head difference based on a height of the nozzle of the printing head and the ink level of the ink cartridge and a method of supplying ink by using a pump.

Examples of known ink supply devices (liquid supply devices) using a pump include a pressure supply type (for example, Japanese Unexamined Patent Application Publication No. 2002-192751) for supplying ink by supplying air, which is pressurized by a pressure pump, into the ink cartridge so as to pressurize an ink pack contained in the ink cartridge, and a feeding pump type (for example, Japanese Unexamined Patent Application Publication No. 2006-272661) for supplying ink by driving the pump provided on the ink flow channel so as to discharge the ink suctioned from the ink cartridge, which is located on the upstream side of the ink flow channel, to the downstream side thereof.

The feeding pump type ink supply device disclosed in Japanese Unexamined Patent Application Publication No. 2006-272661 includes a pulsation type pump such as a diaphragm type pump and a pair of unidirectional valves (check valves) which are provided on the upstream side (for suction) of the pump and the downstream side (for discharge) thereof, respectively. The upstream side unidirectional suction valve (the first unidirectional valve) is opened with ink in an ink induction chamber (a pump chamber) which has been depressurized by performing a suction drive of the pump so as to displace the diaphragm in a direction of increasing the volume of the ink induction chamber. In addition, the valve is maintained in a valve-closed state when the ink in the ink induction chamber is pressurized by performing a discharge drive of the pump so as to displace the diaphragm in a direction of decreasing the volume of the ink induction chamber. On the other hand, the downstream side unidirectional discharge valve (the second unidirectional valve) is maintained in the valve-closed state with the ink in the ink induction chamber depressurized by performing the suction drive of the pump. In addition, the valve is opened with ink in an ink induction chamber being pressurized by performing the discharge drive of the pump. Furthermore, the pump of the liquid supply device repeats the suction drive and the discharge drive, whereby the ink, which is suctioned from the ink cartridge through the upstream side unidirectional valve which is open at the time of the suction drive, is discharged through the downstream side unidirectional valve which is open at the time of the discharge drive. Thus, the ink is supplied to the liquid ejecting head unit through the liquid supply flow channel.

Further, the liquid ejecting apparatus includes a maintenance device (a cleaning section) for cleaning the printing head. In addition, in order to effectively perform the cleaning of the maintenance device, the apparatus may include a valve (a choke valve) for closing the ink flow channel, which communicates with the nozzle, in the path thereof when a negative pressure is applied to the nozzle (for example, Japanese Unexamined Patent Application Publication Nos. 2004-90453 and 2007-216629). At the time of the cleaning, a suction force is applied to the nozzle of the printing head when the choke valve is in a valve-closed state and is provided in the path of the ink flow channel which communicates with the nozzle, thereby creating a negative pressure in the ink in the downstream area of the closed choke valve. Then, the choke valve is opened at the time point when the negative pressure becomes sufficiently high, whereby the ink swiftly flows through the ink flow channel and is discharged from the nozzle. As a result, bubbles and the like staying in the path of the liquid flow channel are discharged. Furthermore, when the bubbles stay in the path of the liquid supply flow channel the bubbles, subsequently, reach the nozzle, thereby causing ejection errors such as a shortage in the amount of ejected ink droplets and dot loss caused when the ink is not ejected.

However, since the feeding pump type liquid supply device is configured to supply the liquid by repeating the suction drive and the discharge drive, the pressure supply of the liquid is temporarily stopped for the next suction drive after a liquid volume that can be sent by a single discharge drive is sent, and the pressure supply of the liquid is restarted when the next discharge drive is restarted. Hence, the liquid is sent intermittently while the pressure supply and the supply stop are alternately repeated.

However, when choke cleaning is performed, the negative pressure in the downstream area of the choke valve becomes sufficiently high. Accordingly, when the discharge drive of the pump is performed, the pressure supply of the liquid is temporarily stopped on purpose to perform the next suction drive at the time point when the feed volume of the liquid for a single discharge drive is completely sent. As described above, when the pressure supply is stopped in the process of the choke cleaning, a force for pushing the liquid is discontinued. Thus, even when the discharge drive is restarted after the termination of the suction drive, the force for pushing the liquid is already lowered. This causes a problem in that this configuration has relatively lower bubble discharge ability than a configuration using a liquid supply device capable of continuously performing the pressure supply.

In particular, the printer disclosed in Japanese Unexamined Patent Application Publication No. 2006-272661 is configured so that the choke valve is provided in the liquid supply device. Therefore, until the choke cleaning is completed, a volume of the liquid supply flow channel in the range from the choke valve to the nozzle should be relatively large, and a plurality of discharge drives should be performed. These cause a problem in that bubble discharge ability is relatively deteriorated.

Further, in the feeding pump type ink supply device, the liquid volume of ink that can be sent by the single discharge drive of the pump is discharged, subsequently the drive of the pump is turned into the suction drive, and the pressure supply of the ink is temporarily discontinued during the time period of the suction drive. During the time period that the ink supply is stopped, the ink stored in the valve chamber of the valve, which is provided in the path of the ink supply flow channel, is supplied to the printing head while the ink in the printing head is consumed.

For example, printing may be performed under the condition in which a large amount of the ink is consumed. In this case, the ink droplets may not be ejected or a pressure of the ink, which is not less than its necessary value, in the printing head may not be secured, because of the ink shortage during the period of the pump suction drive. Accordingly, occurrence of ejection errors such as ejection of excessively small ink droplets is a worry. Here, exemplary cases of printing under the condition in which a large ink ejection amount is required includes using large sized printers for printing, in which a moving distance of the printing head for single scanning is long, and solid printing in which printers other than large sized printers are used.

Hence, in order to avoid the ejection errors, it is necessary to decrease the printing speed of the printing head in accordance with the drive timing of the suction discharge of the pump, or to set a standby time required until the next single scanning can commence whenever single scanning of the printing head is terminated. Accordingly, a problem arises in that such time waste occurs in control.

In Japanese Unexamined Patent Application Publication No. 2006-272661, an ink storage chamber is configured so that an opening of an ink storage chamber casing is choked with a flexible film and a spring, for urging the film outward with a predetermined elastic force, is built into the ink storage chamber casing, and the ink storage chamber is provided in the path of the ink flow channel between the printing head and the unidirectional discharge valve of the pump. However, the ink storage chamber, which replaces a self-sealing valve, functions as a depressurizing device for depressurizing the ink supply pressure generated from the pump to an appropriate ink pressure to be supplied to the printing head, but it is not a buffer for storing the ink to be supplied to the printing head during the suction drive of the pump.

Further, the ink supply device disclosed in Japanese Unexamined Patent Application Publication No. 2006-272661 is not configured to perform the choke cleaning, and thus does not include the choke valve. For example, it is necessary to provide the choke valve in an appropriate position in order to appropriately perform the choke cleaning. However, a disposed position of such a choke valve is not disclosed.

### SUMMARY

An advantage of some aspects of the invention is that it provides a liquid ejecting apparatus and a liquid supply device with the capability of securing a relatively high bubble discharge ability at the time of the choke cleaning of the liquid ejecting head, even in a configuration in which the feeding pump type liquid supply section is provided.

In addition, another advantage of some aspects of the invention is that it provides a liquid ejecting apparatus and a liquid supply device capable of supplying the liquid without any shortage of the liquid in the liquid ejecting head even when the choke cleaning of the liquid ejecting head is performed, even when the feeding pump type liquid supply section is used, and even when the suction drive of the pump is performed.

According to an aspect of the invention, there is provided a liquid supply device provided in a liquid ejecting apparatus which includes a liquid ejecting head having an ejection port for ejecting liquid and a cleaning section for compulsorily discharging the liquid from the ejection port by applying a suction force to the ejecting port of the liquid ejecting head, the liquid supply device supplying the liquid from a liquid supply source to the liquid ejecting head, the liquid supply device including: a liquid supply section that has a pump provided in the path of a liquid supply flow channel for interconnecting the liquid supply source and the liquid ejecting head and a pair of unidirectional valves provided on an upstream side and a downstream side of the pump, and supplies the liquid to the downstream side by performing a suction drive for allowing the pump to suction the liquid from the liquid supply source and a discharge drive for discharging the suctioned liquid; a liquid ejecting head unit that communicates with the liquid supply section through the liquid supply flow channel and has the liquid ejecting head; and a valve section that is provided in the path of the liquid supply flow channel on the downstream side of the pump of the liquid supply flow channel, is maintained in a valve-closed state by the suction force applied to the ejection port, and is opened by a liquid supply pressure generated by the discharge drive of the pump in the valve-closed state, wherein the valve section is provided in the liquid ejecting head unit.

According to this aspect of the invention, the pump of the liquid supply section performs the suction drive and the discharge drive. Thus, the liquid suctioned from the liquid supply source at the time of the suction drive is discharged at the time of the discharge drive, and is supplied to the liquid ejecting head unit through the liquid supply flow channel. Then, the liquid ejecting head ejects the supplied liquid from the ejection port.

At the time of cleaning the liquid ejecting head, the cleaning section is operated to apply a suction force to the ejection port. The valve section is maintained in the valve-closed state by the suction force which is applied to the ejection port, and a negative pressure is created in the downstream area in the range from the valve-closed position of the valve section to the ejection port. Then, the discharge drive of the pump is started at the time point when the negative pressure is sufficiently high, then the valve section is opened by the supply pressure (a discharge pressure) of the liquid created by the discharge drive, and the liquid pressurized on the upstream side of the valve section flows to the downstream area in a short period of time in which a negative pressure is created, which is swiftly discharged from the ejection port. As a result, it is possible to perform effective cleaning (choke cleaning).

In addition, since the valve section is provided in the liquid ejecting head unit, the volume of the liquid supply flow channel from the valve section to the ejection port is small. For example, the volume in such a configuration is smaller than that of the liquid supply flow channel in a configuration in which the valve section is provided in the liquid supply section and a volume of a part of the flow channel interconnecting the liquid supply section and the liquid ejecting head unit is included therein. Hence, the cleaning (the choke cleaning), which causes the liquid to flow in the whole of the downstream area in which a negative pressure is created, can be achieved by the single discharge drive of the pump. For example, when the single discharge drive is terminated in the process of the cleaning before the liquid completely flows throughout the downstream area in which the negative pressure is created, the liquid supply performed by the suction drive of the pump is discontinued in the process thereof, thereby deteriorating the cleaning effect. However, by using the liquid supply device, it is possible to avoid the discontinuance of the cleaning, and thus it is possible to perform effective cleaning capable of securing a favorable bubble discharge ability.

In the liquid supply device of the invention, it is preferable that the valve section has a diaphragm for partitioning a part of a valve chamber, and the diaphragm is a non-spring type differential pressure regulating valve which is not urged by a spring.

According to this aspect of the invention, the diaphragm is a non-spring type differential pressure regulating valve which is not urged by the spring. Therefore, even when the supply pressure of the liquid is lowered at the time of turning the discharge drive of the pump into the suction drive thereof, the valve section (the differential pressure regulating valve) is closed directly in response to the lowering of the supply pressure. As a result, the pressure of the liquid in the downstream area of the valve section is not greatly lowered from the pressure at the time of the discharge drive, and can be maintained to be relatively high. For example, in the case of the spring type differential pressure regulating valve, the valve is opened when a certain pressure is reached, and is firstly closed when a certain pressure is reached. Therefore, even at the time of turning the discharge drive of the pump into the suction drive thereof, a valve close delay, which is a delay in closing the valve after a certain pressure is reached, occurs, and the pressure of the liquid in the downstream area is significantly lowered. The excessive lowering in the pressure of the liquid in the downstream area has an influence on the timing of the opening and closing of a valve mechanism which is provided in the downstream area so as to adjust the supply pressure applied to the liquid ejecting head during the period of the suction drive of the pump. This causes a problem in that the volume of the liquid ejected from the ejection port decreases. The valve section, according to this aspect of the invention, is the non-spring type differential pressure regulating valve. Therefore, it is possible to avoid such a situation.

In the liquid supply device of the invention, it is preferable that the liquid ejecting head is cleaned in a way that the cleaning section is operated in a non drive state or the suction drive state of the pump so as to apply the suction force to the ejection port and thereby create a negative pressure in the downstream area of a valve-closed position of the valve section, and the liquid supply section starts the discharge drive of the pump at a set timing when the negative pressure within the downstream area of the valve section can be considered to be sufficiently high.

According to this aspect of the invention, the cleaning section is operated in the non drive state or the suction drive state of the pump so as to apply the suction force to the ejection port, the negative pressure of the liquid is created by depressurizing the liquid in the downstream area of the valve-closed position of the valve section, and the liquid supply section starts the discharge drive of the pump at a set timing when the negative pressure within the downstream area of the valve section can be considered to be sufficiently high. As a result, the supply pressure (the discharge pressure) of the liquid from the pump reaches the valve section through the liquid supply flow channel, and thus the valve section is opened. Then, the liquid, which is under the supply pressure, flows into the whole of the negative pressure area on the downstream side of the valve-closed position of the valve section in a short period of time. In such a manner, it is possible to perform effective cleaning.

In the liquid supply device of the invention, it is preferable that the cleaning section includes a cap capable of coming into contact with the ejection port formation surface, on which the ejection port is open on the liquid ejecting head, so as to enclose the ejection port, and a suction section capable of applying the suction force to the inside of the cap, and a liquid discharge amount dischargeable for a single discharge drive of the pump is larger than the total volume of the volume of the cap and the volume of the flow channel from a valve-closed position of the valve section to the ejection port.

According to this aspect of the invention, the cleaning (the choke cleaning) can be completed by the single discharge drive of the pump. As a result, it is possible for the liquid to flow into the whole of the negative pressure area on the downstream side of the valve-closed position of the valve section in a short period of time, and thus it is possible to perform cleaning effectively with unwasted cleaning. For example, when the discharge drive of the pump is terminated in the middle of the process of the liquid flowing into the whole of the negative pressure area on the downstream side of the valve-closed position of the valve section, the cleaning is discontinued. However, according to this aspect of the invention, this discontinuance of cleaning can be avoided, and thus it is possible to perform effective cleaning.

In the liquid supply device of the invention, it is preferable that a buffer chamber is provided in the path of the liquid supply flow channel between the valve section and the ejection port in the liquid ejecting head unit so as to store the liquid, which is to be supplied to the liquid ejecting head in the process of the suction drive of the pump, in the process of the discharge drive of the pump.

According to this aspect of the invention, since the buffer chamber is provided in the liquid ejecting head unit, the volume of the flow channel between the liquid supply section and the ejection port increases. However, since the valve section is provided in the liquid ejecting head unit, the flow channel from the valve-closed position of the valve section to the ejection port can be formed so as to have a relatively small volume. Hence, it is possible to complete the cleaning (choke cleaning) by performing a single discharge drive of the pump. Further, the liquid supply to the liquid ejecting head is discontinued during the process of the suction drive of the pump, but the liquid stored in the buffer chamber is supplied toward the downstream side (the ejection port side), whereby there is no shortage of the liquid to be ejected from the ejection port of the liquid ejecting head even during the suction drive of the pump.

In the liquid supply device of the invention, it is preferable that a liquid replenishing mechanism is provided in the path of the liquid supply flow channel between the valve section and the ejection port in the liquid ejecting head unit so as to replenish the liquid ejecting head with an amount of the liquid corresponding to the amount of the liquid consumed by the ejection from the ejection port, by depressurizing the liquid to a supply pressure required for the liquid ejecting head.

According to this aspect of the invention, when the liquid is consumed by ejection from the ejection port, the liquid replenishing mechanism replenishes the liquid ejecting head with an amount of the liquid corresponding to the consumed amount, by depressurizing the liquid to a supply pressure required by the liquid ejecting head.

In the liquid supply device of the invention, it is preferable that the liquid ejecting head unit includes the valve section, a buffer chamber, and the liquid replenishing mechanism, in that order from the upstream side of the liquid supply flow channel.

According to this aspect of the invention, since the valve section is provided on the most upstream side, it is possible to discharge bubbles in the buffer chamber and the chamber of the liquid replenishing mechanism by performing the cleaning. In addition, it is possible to supply the liquid, which is stored in the buffer chamber in the process of the discharge drive of the pump, to the liquid ejecting head by depressurizing the liquid to the required supply pressure through the liquid replenishing mechanism in the process of the suction drive of the pump.

According to another aspect of the invention, there is provided a liquid ejecting apparatus including: a liquid supply device according to the above-described invention; a liquid ejecting head for ejecting liquid, which is supplied from the liquid supply device, from an ejection port; and a cleaning section for compulsorily discharging the liquid from the ejection port by applying a negative pressure to the ejecting port. By using the liquid ejecting apparatus according to this aspect of the invention, it is possible to obtain the same advantage as the liquid supply device according to the aspect of the invention.

According to a further aspect of the invention, there is provided a liquid supply device provided in a liquid ejecting apparatus which includes a liquid ejecting head having an ejection port for ejecting liquid and a cleaning section for compulsorily discharging the liquid from the ejection port by applying a suction force to the ejecting port of the liquid ejecting head, the liquid supply device supplying the liquid from a liquid supply source to the liquid ejecting head, the liquid supply device including: a liquid supply section that has a pump provided in the path of a liquid supply flow channel for interconnecting the liquid supply source and the liquid ejecting head, a first unidirectional valve provided on an upstream side of the pump, and a second unidirectional valve provided on a downstream side of the pump, and supplies the liquid to the downstream side by performing a suction drive for allowing the pump to suction the liquid from the liquid supply source and a discharge drive for discharging the suctioned liquid; a valve section, that is provided in the path of the liquid supply flow channel on the downstream side of the pump of the liquid supply flow channel, is maintained in a valve-closed state by the suction force applied to the ejection port and is opened by a liquid supply pressure generated by the discharge drive of the pump in the valve-closed state; and a buffer chamber that is provided in the path of the liquid supply flow channel on the downstream side of the valve section and which stores the liquid.

According to this aspect of the invention, the pump of the liquid supply section performs the suction drive and the discharge drive. Thus, the liquid suctioned from the liquid supply source at the time of the suction drive is discharged at the time of the discharge drive, and is supplied from the liquid supply section to the liquid ejecting head. Then, the liquid ejecting head ejects the supplied liquid from the ejection port. At this time, when the discharge drive of the pump is turned into the suction drive, the supply of liquid is discontinued during the suction drive. However, since the liquid stored in the buffer chamber is supplied to the liquid ejecting head even in the discontinuance of the liquid supply, it is possible to continue the liquid ejection from the liquid ejecting head. For example, even when a large amount of the liquid is ejected, it is possible to avoid a shortage in the liquid to be ejected by the liquid ejecting head during the period of the suction drive of the pump (the liquid supply discontinuance period).

At the time of cleaning of the liquid ejecting head, the cleaning section applies the suction force to the ejection port. The valve section is maintained in the valve-closed state by the suction force which is applied to the ejection port, and a negative pressure is created in the downstream area in the range from the valve-closed position of the valve section to the ejection port. Then, the discharge drive of the pump is started at the point in time when the negative pressure is sufficiently high, then the valve section is opened by the supply pressure of the liquid, and the liquid under the supply pressure flows in a short period of time to the downstream area in which the negative pressure is created, and is swiftly discharged from the ejection port. Then, it is possible to effectively discharge bubbles in the buffer chamber provided on the downstream side of the valve section by performing the cleaning (the choke cleaning). Since the first unidirectional valve is closed when the valve section is opened by performing the discharge drive of the pump at the time of the cleaning, it is possible to prevent wasteful liquid discharge from the liquid supply source at the time of cleaning.

In the liquid supply device of the invention, it is preferable that the liquid supply device further includes a liquid ejecting head unit that communicates with the liquid supply source or the liquid supply section through a pipe line which is a part of the liquid supply flow channel, and has the liquid ejecting head, wherein the buffer chamber is provided in the liquid ejecting head unit.

According this aspect of the invention, the buffer chamber is provided in the liquid ejecting head unit, and the flow channel from the buffer chamber to the ejection port is formed so as to have a relatively short length. Therefore, it is possible to supply the liquid to the downstream side of the flow channel without greatly lowering the supply pressure of the liquid in the buffer chamber due to pressure loss. For example, a liquid replenishing mechanism including a differential pressure type valve mechanism is provided on the downstream side. The differential pressure type valve mechanism replenishes the liquid ejecting head with an amount of the liquid, corresponding to an amount of the liquid consumed by the liquid ejecting head, while adjusting (depressurizing) the liquid to be supplied to the liquid ejecting head to the supply pressure (a head supply pressure). In this case, there is no great difference between the liquid supply pressures supplied to the valve mechanism (the liquid replenishing mechanism) at the time of the discharge drive of the pump and at the time of the suction drive thereof. Accordingly, it is possible to supply the liquid under the supply pressure (the head supply pressure) required for the liquid ejecting head without causing deviation in the timings of the opening and closing of the valve mechanism at the time of the discharge drive and the suction drive of the pump.

In the liquid supply device of the invention, it is preferable that the valve section is provided in the liquid ejecting head unit.

According to this aspect of the invention, the flow channel from the valve section to the ejection port is formed so as to have a relatively small volume. Therefore, it is possible to complete the cleaning (the choke cleaning) by performing the single discharge drive of the pump. As a result, it is possible to efficiently perform the cleaning.

In the liquid supply device of the invention, it is preferable that the liquid is stored in the buffer chamber in the process of the discharge drive of the pump, and an amount of the liquid, corresponding to an amount of the liquid consumed by the liquid ejecting head in the process of the suction drive of the pump, is supplied from the buffer chamber to the liquid ejecting head, and the buffer chamber is configured so that a pressure of the liquid in the chamber is maintained to be higher than the liquid supply pressure applied to the liquid ejecting head even when the amount of the liquid in the chamber decreases during the process of the suction drive of the pump.

According to this aspect of the invention, in the process of the discharge drive of the pump, the liquid is supplied from the liquid supply section to the liquid ejecting head through the liquid supply flow channel, and is stored in the buffer chamber provided in the path thereof. Then, in the process of the suction drive of the pump, the liquid supply from the liquid supply section is discontinued. However, at this time, an amount of the liquid corresponding to the amount of the liquid consumed in the liquid ejecting head is supplied from the buffer chamber. In this case, even when the amount of the liquid in the buffer chamber decreases, the pressure of the liquid in the chamber is maintained to be higher than the liquid supply pressure applied to the liquid ejecting head. Therefore, it is possible to supply the liquid under the supply pressure required for the liquid ejecting head without causing deviation in the timings of the opening and closing of, for example, the differential pressure type valve mechanism which is provided on the downstream side of the buffer chamber.

In the liquid supply device of the invention, it is preferable that the buffer chamber has a flexible member for partitioning at least a part of a liquid storage chamber which stores the liquid, and the flexible member is a non-depressurization type which is not urged by a spring in a direction of depressurizing the liquid in the liquid storage chamber.

According to the aspect of the invention, when the liquid under a predetermined supply pressure (a positive pressure) is stored in the buffer chamber, the flexible member expands toward the outside of the liquid storage chamber. Subsequently, in the process of the suction drive of the pump, when the liquid is consumed by ejection from the ejection port, the amount of the liquid in the buffer chamber decreases, and then the flexible member is deformed toward the inside of the liquid storage chamber, thereby decreasing the volume of the chamber. At this time, a restorative force (a force in a direction of increasing the chamber volume) that restores the flexible member, which is deformed toward the inside of the liquid storage chamber, to the original form is applied to the liquid in the chamber, thereby depressurizing the liquid in the chamber. However, since the buffer chamber is a non-depressurization type, the restorative force is excessively smaller than the force (a total force comprised of the restorative force of the flexible member and the elastic force of the spring) that acts on the flexible member so as to displace it outward in a depressurization type in which the flexible member is urged outward by the spring. Accordingly, the pressure of the liquid stored in the buffer chamber is not lowered to the value of the head supply pressure or less, and can be maintained to be higher than the head supply pressure. Hence, it is possible to supply the liquid under, for example, the head supply pressure which is required for the liquid supply head.

In the liquid supply device of the invention, it is preferable that the valve section has a diaphragm for partitioning a part of a valve chamber, and is a differential pressure regulating valve which is opened and closed by deforming the diaphragm on the basis of the pressure difference of both sides with an interval therebetween so that the diaphragm comes into contact with or separates from a valve seat.

According to this aspect of the invention, the flexible member is deformed on the basis of the pressure difference of both sides of the flexible member which partition a part of the valve chamber of the differential pressure regulating valve (the valve section). Then, the differential pressure regulating valve is opened or closed by making the flexible member come into contact with or separate from a valve seat. For example, the supply pressure of the liquid from the liquid supply section starts to be lowered by turning the discharge drive of the pump into the suction drive thereof, and then the differential pressure regulating valve is immediately closed by the pressure difference, which is caused by the lowering of the supply pressure, between the sides of the flexible member. Accordingly, the discharge pressure can be maintained even on the downstream side of the differential pressure regulating valve (valve section) without greatly lowering the pressure. As a result, in the process of the suction drive of the pump, the liquid in the downstream area (which includes the buffer chamber) of the valve section can be maintained at a relatively high pressure.

In the liquid supply device of the invention, it is preferable that a liquid replenishing mechanism is provided in the path of the liquid supply flow channel on the downstream side of the buffer chamber so as to replenish the liquid ejecting head with an amount of the liquid, corresponding to an amount of the liquid consumed by the ejection from the ejection port, by depressurizing the liquid to a supply pressure required for the liquid ejecting head.

According to this aspect of the invention, when the liquid is consumed by ejection from the ejection port, the liquid replenishing mechanism replenishes the liquid ejecting head with an amount of the liquid, corresponding to the consumed amount, by depressurizing the liquid to a supply pressure (the head supply pressure) required for the liquid ejecting head.

According to a still further aspect of the invention, there is provided a liquid ejecting apparatus including: a liquid supply device according to the above-described invention; a liquid ejecting head for ejecting liquid, which is supplied from the liquid supply device, from an ejection port; and a cleaning section for compulsorily discharging the liquid from the ejection port by applying negative pressure to the ejecting port. By using the liquid ejecting apparatus according to this aspect of the invention, it is possible to obtain the same advantage as the liquid supply device according to the aspect of the invention.

### BRIEF DESCRIPTION OF THE DRAWINGS

The invention will be described with reference to the accompanying drawings, wherein like numbers reference like elements.

FIG. 1 is a top plan view schematically illustrating an ink jet printer according to an embodiment.

FIG. 2 is a sectional view schematically illustrating the printer.

FIG. 3A is a sectional view schematically illustrating an ink supply device at the time of suction drive.

FIG. 3B is a sectional view schematically illustrating the ink supply device at the time of discharge drive.

FIG. 4 is a sectional view schematically illustrating the printing head unit.

FIG. 5 is a graph illustrating time-series variation of an ink pressure in a pump drive process.

FIG. 6 is a graph illustrating time-series variation of ink pressure in a pump drive process according to a comparative example.

### DESCRIPTION OF EXEMPLARY EMBODIMENTS

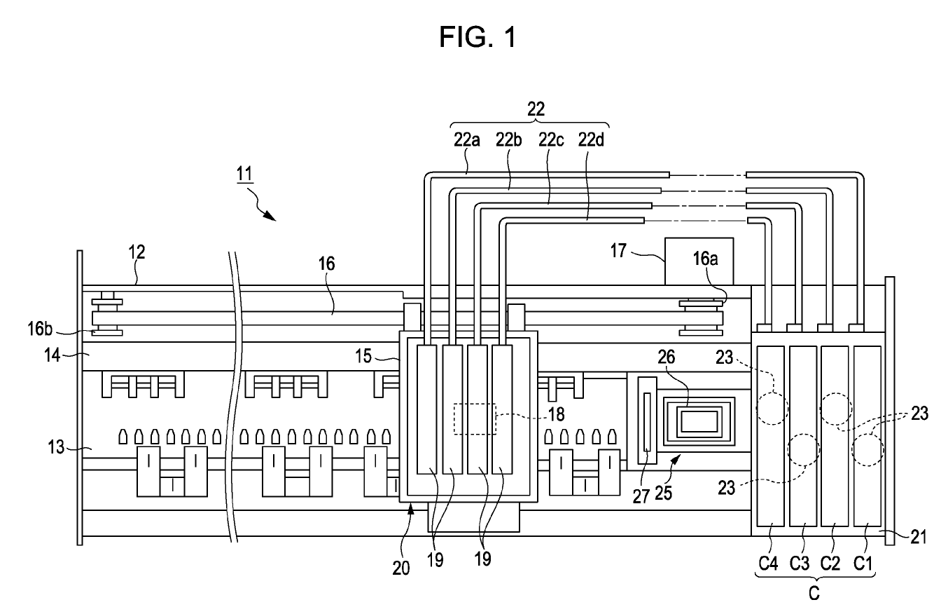

Hereinafter, an ink jet printer as a specific example of a liquid ejecting apparatus according to an embodiment of the invention will be described with reference to FIGS. 1 to 6.

FIG. 1 is a top plan view schematically illustrating the ink jet printer. As shown in FIG. 1, the ink jet printer (hereinafter, it is simply referred to as a “printer 11”) as the liquid ejecting apparatus includes a main body casing 12 formed in a substantially rectangular box shape that opens toward the top (the front direction perpendicular to the plane of paper in FIG. 1). A platen 13 is provided along a lengthwise direction of the main body casing 12 at a position close to the bottom in the main body casing. Printing papers (not shown) as a target is fed on the platen 13 in a sub-scanning direction (the vertical direction in FIG. 1) by a paper feeding mechanism which is not shown. In addition, a guide shaft 14 having a rod shape is provided in the main body casing 12 in parallel to a lengthwise direction of the platen 13.

A carriage 15 is supported by the guide shaft 14 so as to be able to reciprocate in a direction of the axis of the guide shaft 14. The carriage 15 is fixed on a part of an endless timing belt 16 which is stretched between a pair of pulleys 16a and 16b. A carriage motor 17 is disposed on a position on the right side of the rear wall of the main body casing 12. The driving shaft of the carriage motor 17 is connected to the pulley 16a to rotate the pulley 16a. When the carriage motor 17 is forwardly and reversely driven, the timing belt 16 is forwardly and reversely rotated, and the carriage 15 is adapted to be reciprocated along the guide shaft 14 in a main scanning direction (the horizontal direction in FIG. 1).

A printing head 18 as a liquid ejecting head is provided on a side of the carriage 15 facing the platen 13. In addition, a plurality of valve units 19 is provided on the carriage 15. Each valve unit adjusts the pressure of the ink supplied to the printing head 18. The number of the valve units is the same as that of ink colors (in the present embodiment, four). The printing head 18, which is reciprocated with the carriage 15 in the main scanning direction, ejects the ink onto the printing paper (not shown) fed on the platen 13, thereby performing printing. Furthermore, a printing head unit 20 includes the carriage 15, the printing head 18, and the valve unit 19, and is able to move in the main scanning direction.

An ink supply device 21 as a liquid supply section is provided on one end (the right end in FIG. 1) of the main body casing 12. The ink supply device 21 according to the embodiment also functions as a cartridge holder, and ink cartridges C1 to C4 as a plurality (in FIG. 1, four) of liquid supply sources (liquid containers) are detachably mounted. These ink cartridges C are connected to the corresponding valve units 19 through ink supply tubes 22a to 22d (liquid supply flow channels) as pipe lines so as to be able to supply the ink to the valve units. The ink supply device 21 according to the embodiment adopts a feeding pump type, and includes a plurality of pulsation type pumps 23 (in this example, four) corresponding to the ink cartridges C1 to C4. Each pump 23 supplies the pressurized ink to the valve unit 19 of the printing head unit 20 by alternately repeating a suction drive for suctioning the ink from the ink cartridge C and a discharge drive for discharging the suctioned ink. Furthermore, in the embodiment, if there is no need to distinguish the ink cartridges C1 to C4, it is simply referred to as the ink cartridge C for convenience of description. Likewise, if there is also no particular need to distinguish the ink supply tube 22a to 22d, it is simply referred to as the ink supply tube 22 for convenience of description.

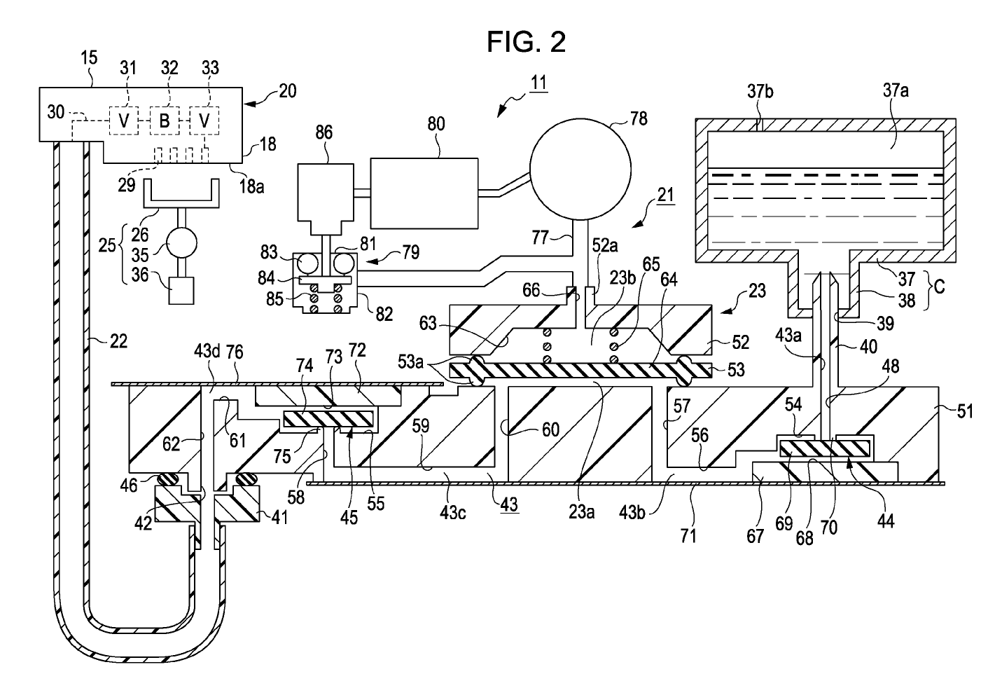

Further, as shown in FIG. 1, a maintenance device 25 as a cleaning section is provided on a position corresponding to a home position which is a standby position of the carriage 15 in the main body casing 12 at the time of non-printing. The maintenance device 25 includes a cap 26 and a wiper 27. The cap 26 has a rectangular box shape that opens toward the top, and is provided so as to be able to be moved up and down by an elevating mechanism which is not shown. When the carriage 15 reaches the home position, the cap 26 is moved up by the elevating mechanism, and comes into contact with the nozzle formation surface 18a (refer to FIG. 2) of the printing head 18, thereby performing the capping. A maintenance device 25 applies a suction force to the inside of the cap 26 which is capping the printing head 18 so as to create negative pressure in the cap 26, thereby performing cleaning for compulsorily discharging the ink from the nozzle 29 (refer to FIG. 2) of the printing head 18. Due to the cleaning, printing error is prevented by suctioning and removing bubbles and foreign particles (paper particles and the like) mixed in the ink in the ink flow channel and by suctioning and removing thickened ink in the ink flow channel which communicates with the nozzle 29 of the printing head 18. The wiper 27 wipes out the nozzle formation surface 18a of the printing head 18 while the carriage 15 is moved away from the home position after the cleaning, thereby making the ink meniscuses present in the nozzles 29 be in order.

Next, the feeding pump type ink supply device will be described with reference to FIG. 2. FIG. 2 is a sectional view schematically illustrating the ink supply device. Furthermore, FIG. 2 shows only the ink pressure supply system for one ink cartridge C for convenience of description.

As shown in FIG. 2, in the printing head 18, a plurality of the nozzles 29 (in the embodiment, four) corresponding to the number of the installed ink supply devices 21 is formed as openings on the nozzle formation surface 18a facing the platen 13 (refer to FIG. 1). In addition, the ink, which is supplied from each ink supply device 21 to the ink flow channel 30 in the printing head unit 20 through the ink supply tube 22, is supplied to the nozzle 29 by passing through a choke valve 31 as a valve section provided on an ink flow channel 30, a buffer 32 as a buffer chamber, and a self-sealing valve 33 as a liquid replenishing mechanism.

Here, the choke valve 31 is a valve which is able to block the ink flow channel 30 at a position located in the path thereof by closing the valve so that the choke cleaning to be described later is performed during the maintenance of the printing head 18. Hence, the choke valve 31 is normally maintained in its open state, other than at the time of cleaning, including during the time required for the printing.

Further, the buffer 32 is an ink storage chamber for temporarily storing the ink. For example, even when the amount of ink, which is ejected from the nozzle 29 of the printing head 18, enough for one scanning is excessively large similarly to the solid printing, and even when the ink supply is discontinued for the suction drive of the pump 23, it is possible to secure sufficient ink for the printing head unit 20 by using the buffer 32 which is provided for previously storing extra ink. The buffer 32 is set to have a chamber volume capable of storing an amount of ink obtained by adding a small margin to the maximum amount of ink. Here, the maximum amount of ink is the maximum of the amount which is considered to be required for replenishing the printing head 18 during the period in which the ink supply is discontinued for the suction drive of the pump 23.

Furthermore, the self-sealing valve 33 is a valve which is opened and closed to replenish an amount of ink corresponding to an amount of ink consumed by ejecting ink while adjusting the ink to the ink pressure (a head supply pressure) required for the printing head 18 when the ink is ejected from the nozzle 29. The self-sealing valve 33 according to the embodiment is a diaphragm-type differential pressure regulating valve which is opened and closed by using a differential pressure between the ink pressure and the atmospheric pressure. In the valve, it is necessary to apply a predetermined ink pressure to an ink chamber of the self-sealing valve 33, to be described later, in order to apply an appropriate ink pressure to the printing head 18. The configurations of the choke valve 31, the buffer 32, and the self-sealing valve 33 will be described in detail later. Furthermore, a plurality of openings of each of the four nozzles 29 are arranged in a nozzle array with a regular nozzle pitch in a direction orthogonal to the plane of paper in FIG. 2. The direction of the nozzle array (the direction orthogonal to the plane of paper in FIG. 2) coincides with the paper transporting direction in a serial printer.

The maintenance device 25, which cleans the printing head 18 in order to remove clogging of the nozzle 29 of the printing head 18, includes a cap 26 which is able to come into contact with the nozzle formation surface 18a of the printing head 18 so as to enclose the nozzle 29, a suction pump 35 as a suction section which is driven when suctioning the ink from the inside of the cap 26, and a waste tank 36 to which the ink suctioned from the cap 26 by driving the suction pump 35 is discharged as waste ink. At the time of cleaning, the maintenance device 25 moves up the cap 26, which is in the state shown in FIG. 2, and drives the suction pump 35 in a state where the cap 26 is in contact with the nozzle formation surface 18a of the printing head 18. Then, the suction pump 35 creates negative pressure in a space in the cap 26 by applying a suction force thereto, and suctions thickened ink and ink mixed with bubbles from the nozzle 29 of the printing head 18 so as to discharge the suctioned ink to the waste tank 36 by using the negative pressure. In this case, the choke valve 31 is turned to the valve-closed state, and the ink pressure in the flow channel including the chambers of the buffer 32 and the self-sealing valve 33 changes to negative pressure. Then, the choke valve 31 is opened by starting the discharge drive of the pump 23. In such a manner, choke cleaning is performed which flows the pressurized ink, which is supplied by the pump 23, to the whole area under negative pressure on the downstream side of the valve-closed position of the choke valve 31 over a short period of time.

On the other hand, the ink cartridge C includes a casing 37 having a substantially rectangular box shape of which the inside is an ink chamber 37a for containing ink. A tube portion 38 which communicates with the ink chamber 37a and is formed through the bottom of the casing 37 to be projected downward, and an ink supply port 39 which is able to draw ink is formed through the leading end of the tube portion 38. The ink cartridge C is configured to be connected to the ink supply device 21 by inserting the ink supply needle 40, which is projected from the ink supply device 21, into the ink supply port 39. Further, an air ventilating hole 37b for ventilating the ink chamber 37a in which the ink is contained is formed through the top of the casing 37, and is configured to apply atmospheric pressure to the liquid surface of the ink contained in the ink chamber 37a.

Next, the configuration of the ink supply device 21 will be described in detail.

As shown in FIG. 2, the ink supply device 21 includes an ink flow channel 43 which is a part of the liquid supply flow channel for interconnecting the ink supply needle 40 and an ink outlet 42 (an ink discharge port). The ink outlet 42 communicates with the ink supply tube 22 through a connection port 41. In addition, the ink supply device 21 includes, in the path of the ink flow channel 43, the above-mentioned pulsation type pump 23 (the diaphragm type pump), a unidirectional suction valve 44 (a check valve for suctioning) which is provided on the upstream side of the pump 23, and a unidirectional discharge valve 45 (a check valve for discharge) provided on the downstream side of the pump 23. Furthermore, the connection port 41 is mounted on the end of the rear wall of the ink supply device 21 with a sealing member 46 such as an O-ring interposed therebetween, and interconnects the ink supply tube 22 and the ink outlet 42.

As shown in FIG. 2, the ink supply device 21 includes a first flow channel forming member 51 which is a base made of a synthetic resin, a second flow channel forming member 52 which is made of resin similarly and is assembled to be layered on the first flow channel forming member 51, and a flexible member 53 which is formed of a rubber plate, and the like, interposed between both of the flow channel forming members 51 and 52 at the time of assembly.

Here, a recessed portion 54, which has a circular shape in plan view, is formed on one end (the right end in FIG. 2) of the lower surface of the first flow channel forming member 51. A recessed portion 55, which also has a circular shape in plan view, is formed on the other end (the left end in FIG. 2) of the upper surface thereof. Two recessed portions 54 and 55 have the same inner diameter and depth.

As shown in FIG. 2, the recessed portion 54 is located just below the ink supply needle 40, and a through-hole 48 which communicates with the hole of the ink supply needle 40 opens toward the bottom of the recessed portion 54. The recessed portion 54 opens toward the upper surface of the first flow channel forming member 51, through a groove 56 and a through-hole 57. The groove 56 is formed on the rear wall of the first flow channel forming member 51, and the through-hole 57 is formed to penetrate through the first flow channel forming member 51 in a thickness direction. The recessed portion 55 opens to the upper surface of the first flow channel forming member 51 through a through-hole 58, a groove 59, and a through-hole 60. The through-hole 58 is formed to penetrate through the first flow channel forming member 51 in the thickness direction. The groove 59 is formed on the rear wall of the first flow channel forming member 51. The through-hole 60 is formed to penetrate through the first flow channel forming member 51 in the thickness direction. In addition, the recessed portion 55 communicates with the ink outlet 42 through a groove 61 and a through-hole 62. The groove 61 is formed on the end (the left end in FIG. 2) of the upper surface of the first flow channel forming member 51. The through-hole 62 is formed to penetrate through the first flow channel forming member 51 in the thickness direction. Furthermore, the two through-holes 57 and 60 open at two positions in the disposition area of the flexible member 53 on the upper surface of the first flow channel forming member 51.

The second flow channel forming member 52 is layered on the first flow channel forming member 51 with the flexible member 53 interposed therebetween. A recessed portion 63, which has a truncated cone shape, is formed on the lower surface of the second flow channel forming member 52. The flexible member 53 is interposed between the upper surface of the first flow channel forming member 51 and the recessed portion 63 of the second flow channel forming member 52 so as to partition those into up and down. The flexible member 53 is liquid-tightly sealed around the peripheries on the both surfaces of the flexible member 53 by interposing the sealing portions 53a, which are projected at the peripheries, between the first flow channel forming member 51 and the second flow channel forming member 52. A circular part of the flexible member 53 enclosed by the sealing portions 53a in plan view functions as a diaphragm 64 which can be displaced by elastic deformation.

As shown in FIG. 2, the part of the flexible member 53 acting as the diaphragm 64 is urged downward by the elastic force of the coil spring 65 disposed inside the recessed portion 63 above the flexible member 53. In the embodiment, the pulsation type pump 23 includes the approximately central portion on the upper surface of the first flow channel forming member 51, the second flow channel forming member 52, the diaphragm 64, and the coil spring 65. Here, a volume variable space is enclosed by the diaphragm 64 and the upper surface of the first flow channel forming member 51 on the lower side of the diaphragm 64. The volume variable space functions as the pump chamber 23a in the pump 23. The pump chamber 23a communicates with the two through-holes 57 and 60. Another volume variable space is enclosed by the diaphragm 64 and the recessed portion 63 of the second flow channel forming member 52 on the upper side of the diaphragm 64. The volume variable space functions as a negative pressure chamber 23b in the pump 23. Furthermore, a pipe portion 52a is projected on the upper surface of the second flow channel forming member 52. A through-hole 66 communicating with the negative pressure chamber 23b is formed so as to penetrate the pipe portion 52a.

The unidirectional suction valve 44 includes a valve chamber 68, which is enclosed by the recessed portion 54 and a blocking member 67, and a valve plug 69 which is formed of a rubber piece having a circular plate shape housed in the valve chamber 68. The blocking member 67 is intrusively or threadedly engaged to cap the opening of the recessed portion 54. A valve seat 70 as a projection portion having an annular shape which encloses the opening of the through-hole 48 is formed on the bottom of the recessed portion 54. The valve plug 69 is movable between a valve-closed position at which it is in contact with the valve seat 70 and a valve-opened position at which it is separated from the valve seat 70 and is in contact with the inside bottom surface of the blocking member 67. Specifically, the unidirectional suction valve 44 is closed by bringing the valve plug 69 into contact with the valve seat 70, and is opened by separating the valve plug 69 from the valve seat 70. Furthermore, a first ink flow channel 43a includes the hole of the ink supply needle 40 and the through-hole 48. The first ink flow channel 43a interconnects the ink supply port 39 of the ink cartridge C and the unidirectional suction valve 44.

Here, a gap between the valve plug 69 and the valve seat 70 in the valve-opened state of the unidirectional suction valve 44 is set to be relatively small. In this case, when ink flow, which flows from the central opening of the valve seat 70 into the first ink flow channel 43a, is generated, the flow is able to attract the valve plug 69. Thus, the valve plug 69 is moved to the valve-closed position. A film 71 is thermally adhered onto the outer surface of the blocking member 67 and the rear wall of the first flow channel forming member 51 in the area including the grooves 56 and 59. A second ink flow channel 43b is formed to interconnect the valve chamber 68 of the unidirectional suction valve 44 and the pump chamber 23a of the pump 23 through the through-hole 57 and the space which is enclosed by the groove 56 and the film 71.

The unidirectional discharge valve 45 includes a valve chamber 73, which is enclosed by the recessed portion 55 and a blocking member 72, and a valve plug 74 which is formed of a rubber piece having a circular plate shape housed in the valve chamber 73. The blocking member 72 is intrusively or threadedly engaged to cap the opening of the recessed portion 55. The valve chamber 73 communicates with the pump chamber 23a of the pump 23 through a third ink flow channel 43c. The third ink flow channel 43c includes the space, which is enclosed by the groove 59 and the film 71, and the two through-holes 58 and 60.

A valve seat 75 as a projection portion having an annular shape which encloses the opening of the through-hole 58 is formed on the bottom of the recessed portion 55. The valve plug 74 is movable between a valve-closed position at which it is in contact with the valve seat 75 and a valve-opened position at which it is separated from the valve seat 75 and is in contact with the inside bottom surface of the blocking member 72. Specifically, the unidirectional discharge valve 45 is closed by bringing the valve plug 74 into contact with the valve seat 75, and is opened by separating the valve plug 74 from the valve seat 75.

Here, a gap between the valve plug 74 and the valve seat 75 in the valve-opened state of the unidirectional discharge valve 45 is set to be relatively small. In this case, when ink flow, which flows from the central opening of the valve seat 75 into the third ink flow channel 43c, is generated, the flow attracts the valve plug 74. Thus, the valve plug 74 is moved to the valve-closed position. A film 76 is thermally adhered onto the outer surface of the blocking member 72 and the upper surface of the first flow channel forming member 51 in the area including the groove 61. A fourth ink flow channel 43d is formed to interconnect the valve chamber 73 of the unidirectional discharge valve 45 and the ink outlet 42 through the through-hole 62 and the space which is enclosed by the groove 61 and the film 76.

As shown in FIG. 2, the pipe portion 52a of the pump 23 is connected with an air open mechanism 79 and a negative pressure generator 78 including a suction pump, and the like, through the air flow channel 77 having two branches. The negative pressure generator 78 creates a negative pressure by using a driving force transferred from a drive motor 80, which can be reversely and forwardly driven, through a one-way clutch which is not shown when the drive motor 80 is forwardly driven. Then, the negative pressure is applied to the negative pressure chamber 23b of the pump 23 connected through an air flow channel 77.

The air open mechanism 79 houses an air open valve 84 formed by adding a sealing member 83 to an air open hole 81 in a box 82 having the air open hole 81 formed thereon. The air open valve 84 is continuously urged by the elastic force of a coil spring 85 in the valve-closed direction for sealing the air open hole 81. In addition, in the air open mechanism 79, when the drive motor 80 is reversely driven, a cam mechanism 86 is operated on the basis of the driving force transferred by the one-way clutch which is not shown. Then, the operation of the cam mechanism 86 makes the air open valve 84 be displaced against the elastic force of the coil spring 85 in the valve-opened direction. Specifically, when a negative pressure is created in the negative pressure chamber 23b which is connected to the air open mechanism 79 through the air flow channel 77, the air open mechanism 79 release the negative pressure state by opening the air open valve 84 to ventilate the inside of the negative pressure chamber 23b.

Furthermore, the ink supply device 21 includes a plurality of ink supply sections. Each ink supply section includes the pump 23 and the pair of unidirectional valves 44 and 45. The number of the ink supply sections is the same as that of ink colors (in this example, four). In addition, a plurality (in this example, four) of branched leading ends of the air flow channel 77 are connected to the respective pipe portions 52a of the pumps 23. Thus, the negative pressure generator 78, the air open mechanism 79, and the drive motor 80 are commonly used among the plurality of pumps 23.

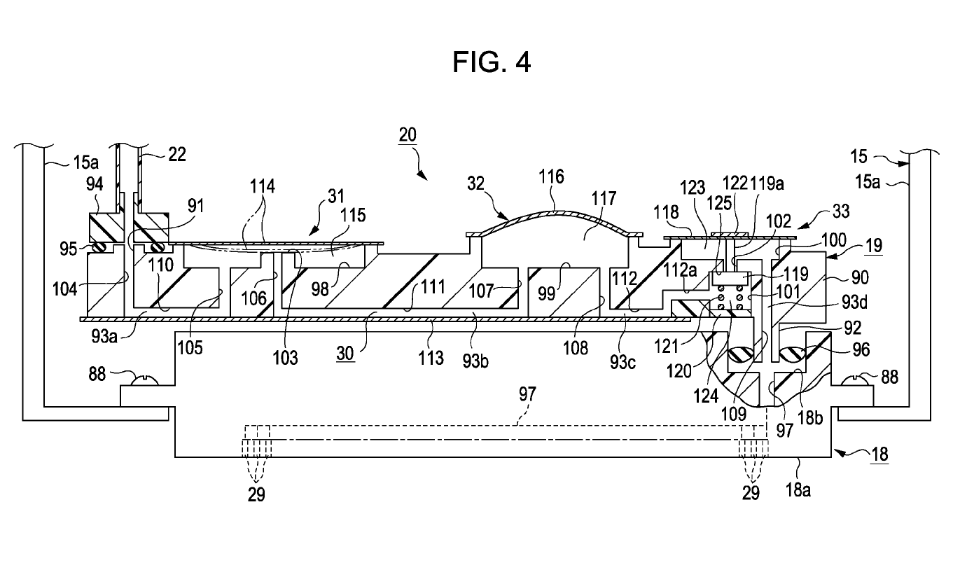

Next, the configurations and functions of the choke valve 31, the buffer 32, and the self-sealing valve 33, which are built in the printing head unit 20, will be described. FIG. 4 is a sectional view schematically illustrating the printing head unit.

As shown in FIG. 4, the printing head 18 is fixed by screws 88 on a pair of supporting arms 15a, which extend downward from the carriage 15 of the printing head unit 20, while being supported in a horizontal posture so as to face the nozzle formation surface 18a to the platen 13 (refer to FIG. 1). In addition, the valve unit 19 is disposed on the upper side of the printing head 18. In this state, the valve unit 19 is fixed on the carriage 15 with an unillustrated supporting section interposed therebetween. The valve unit 19 includes a flow channel forming member 90 having a planar shape.

The flow channel forming member 90 has an ink inlet 91 which opens to the left end portion on the upper surface of the member shown in FIG. 4, a pipe portion 92, which is projected from the right end portion on the lower surface thereof, for drawing ink, and the ink flow channel 30 which interconnects the ink inlet 91 and the pipe portion 92. The choke valve 31, the buffer 32, and the self-sealing valve 33 are disposed in the path of the ink flow channel 30 in that order from the upstream side (the ink inlet 91 side) thereof.

A pipe connection port 94 is provided on the other end (the downstream end) of the ink supply tube 22. The pipe connection port 94 is mounted on a mounting location on the left end portion on the upper surface of the valve unit 19 with the sealing member 95 interposed therebetween. Thereby, the ink supply tube 22 communicates with the ink inlet 91. As shown in FIG. 4, the pipe portion 92 is inserted into the recessed portion 18b which is recessed into the right end portion on the upper surface of the printing head 18 with the sealing member 96 interposed therebetween. The sealing member 96 is formed in an annular shape around the outer circumference of the pipe portion 92. With such a configuration, the ink flow channel 93 of the valve unit 19 is connected to the ink flow channel 97 of the printing head 18.

Three recessed portions 98, 99, and 100 having a circular shape in plan view are arranged horizontally parallel to the upper surface of the flow channel forming member 90 in this order from the left side of the member in FIG. 4. A recessed portion 101 is recessed into the right end portion on the rear wall of the flow channel forming member 90. The recessed portion 101 faces the recessed portion 100 in the thickness direction. These two recessed portions 100 and 101 communicate with each other through a communicating hole 102 which penetrates through the flow channel forming member 90 in the thickness direction thereof. A tube portion 103 is projected from the central portion of the bottom of the recessed portion 98.

Six through-holes 104 to 109 which constitute a part of the ink flow channel 30 are formed on the flow channel forming member 90. Specifically, in order from the left side of FIG. 4, there are provided the through-hole 104 which communicates with the ink inlet 91, the through-hole 105 which opens to the outside of the tube portion 103 on the bottom of the recessed portion 98, the through-hole 106 which communicates with the tube portion 103, a pair of through-holes 107 and 108 which open to the bottom of the recessed portion 99, and the through-hole 109 which communicates with the pipe portion 92. In addition, those holes are formed through the flow channel forming member 90 in the thickness direction thereof. Three grooves 110 to 112 which also constitute a part of the ink flow channel 30 are formed on the rear wall of the flow channel forming member 90. Specifically, there are provided the groove 110 which interconnects the two through-holes 104 and 105, the groove 111 which interconnects the two through-holes 106 and 107, and the groove 112 which interconnects the through-hole 108 and a communicating hole 112a. The communicating hole 112a opens to the side wall of the recessed portion 101.

A film 113 is thermally adhered to the rear wall of the flow channel forming member 90 in an area including the grooves 110 to 112. A first flow channel 93a is formed by the space, which is enclosed by the groove 110 and the film 113, and two through-holes 104 and 105. A second flow channel 93b is formed by the space, which is enclosed by the groove 111 and the film 113, and the two through-holes 106 and 107. A third flow channel 93c is formed by the space, which is enclosed by the groove 112 and the film 113, the communicating hole 112a, and the through-hole 108. A fourth flow channel 93d is formed by the through-hole 109. The first to fourth flow channels 93a to 93d constitute the ink flow channel 30.

The choke valve 31 is formed on the upper surface of the flow channel forming member 90 by the recessed portion 98, the tube portion 103, and the film 114. The film 114 is thermally adhered to block the opening of the recessed portion 98. The space, which is enclosed by the recessed portion 98 and the film 114, serves as an ink chamber 115. The film 114 is separated from the surface of the top of the tube portion 103 in a state where the film 114 is not deformed (the state indicated by the solid line in FIG. 4). In contrast, when the ink chamber 115 starts to be depressurized by starting to lower the pressure of the pressurized ink which is supplied to the ink chamber 115 through the first flow channel 93a, or when a suction force for drawing ink is applied to the inside of the tube portion 103 through the second flow channel 93b, the film 114 closes the valve by coming into contact with the surface of the top of the tube portion 103, as indicated by the chain double-dashed line in FIG. 4.

The buffer 32 is formed by the recessed portion 99 and a film 116. The film 116 is thermally adhered to the upper surface of the flow channel forming member 90 so as to block the opening of the recessed portion 99. The space, which is enclosed by the recessed portion 99 and the film 116, serves as an ink storage chamber 117. The film 116 may not be loose, but in this example, it is thermally adhered to be slightly loose.

As shown in FIG. 4, the self-sealing valve 33 includes the recessed portion 100 and a film 118. The film 118 is thermally adhered to the upper surface of the flow channel forming member 90 so as to block the opening of the recessed portion 100. Furthermore, the self-sealing valve 33 includes a valve plug 119 and a coil spring 121. The valve plug 119 is housed in the recessed portion 101 with the shaft portion 119a inserted into the communicating hole 102. The coil spring 121 is interposed between the valve plug 119 and the blocking member 120, which is intrusively or threadedly engaged so as to cap the opening of the recessed portion 101, thereby urging the valve plug 119 in a direction in which the shaft portion 119a presses the film 118 outward. A pressure receiving plate 122 is fixedly attached to the film 118 at the location at which the shaft portion 119a of the valve plug 119 comes into contact with the film 118. In addition, the space, which is enclosed by the recessed portion 100 and the film 118, serves as a pressure chamber 123. The space, which is enclosed by the recessed portion 101 and the blocking member 120, serves as an ink chamber 124. A part, which comes into contact with the valve plug 119, around the communicating hole 102 serves as the valve seat 125. The valve plug 119 is provided with a sealing portion (not shown) having an annular shape at a part which is able to come into contact with the valve seat 125.

Aluminum deposition films are used in the films 71, 76, and 113 which constitute the follow channel, and silica deposition films are used in the films 114, 116, and 118 which function as diaphragms in the choke valve 31, the buffer 32, and the self-sealing valve 33. When the silica deposition film is used, the silica deposition film is scarcely stripped off as compared with the aluminum deposition film even when the film is repeatedly deformed, and its gas permeability based on a deposited material can be kept low. Thus, it is possible to effectively prevent the film from allowing gas such as air to permeate through the film and be dissolved in the ink.

The ink chamber 115 of the choke valve 31 communicates with the ink supply tube 22 through the first flow channel 93a, and the tube portion 103 communicates with the ink storage chamber 117 of the buffer 32 through the second flow channel 93b. The ink storage chamber 117 of the buffer 32 communicates with the ink chamber 124 of the self-sealing valve 33 through the third flow path 93c. The pressure chamber 123 of the self-sealing valve 33 communicates with the ink flow channel 97 close to the printing head 18 through the fourth flow channel 93d.

In the printing head 18, the ink flow channel 97 communicates with the nozzles 29. In addition, in the printing head 18, ejecting elements (not shown), which are formed by, for example, piezoelectric elements, electrostatic elements, or heaters, are provided in the respective nozzles 29. When current is applied to each ejecting element, an ejecting pressure is applied to each ink in the chambers which are partitioned to communicate with the respective nozzles 29, whereby the printing head 18 is configured to eject ink droplets from the corresponding nozzles.

When the ink is consumed by ejecting the ink from the nozzle 29, an amount of the ink in the pressure chamber 123 is decreased, and the ink pressure is depressurized. On the basis of a differential pressure between the atmospheric pressure and the depressurized ink pressure in the pressure chamber 123, the film 118 is deformed toward the pressure chamber 123. Thus, the valve plug 119 is moved toward the valve-opened position against the elastic force of the coil spring 121. In such a manner, the self-sealing valve 33 is opened, and the ink flows from the ink chamber 124 into the pressure chamber 123. When the ink flows in the pressure chamber 123, subsequently the elastic force of the coil spring 121 overcomes the force transferred from the film 118 to the valve plug 119, thereby moving the valve plug 119 to the valve-closed position again. As described above, the ink appropriately flows in the printing head 18 by opening and closing the self-sealing valve 33 in accordance with the ink consumption.

In addition, the self-sealing valve 33 is a differential pressure regulating valve having a configuration in which the film 118 is pressed by the elastic force of the coil spring 121 through the valve plug 119 toward the outside of the pressure chamber 123. Therefore, the ink pressure within the pressure chamber 123 is maintained at a negative pressure. A spring constant of the coil spring 121 is set so that the ink pressure (the negative pressure) of the pressure chamber 123 is equal to the supply pressure (the head supply pressure) of the ink to be supplied to the printing head 18. Accordingly, the ink supplied to the ink chamber 124 of the self-sealing value 33 is supplied to the ink flow channel 97 of the printing head 18 through the fourth flow channel 93d while being depressurized in the pressure chamber 123. Here, the timing of opening and closing of the self-sealing valve 33 is determined on balance from among the elastic force of the coil spring 121, the restorative force of the film 118, and the respective forces applied in the valve-closed direction and in the valve-opened direction to the valve plug 119 by the ink pressure within the ink chamber 124 and the ink pressure within the pressure chamber 123. Hence, in order to maintain the ink pressure within the pressure chamber 123 at the head supply pressure in a predetermined allowable range, it is necessary to maintain the ink pressure, which is supplied to the ink chamber 124, without great change.

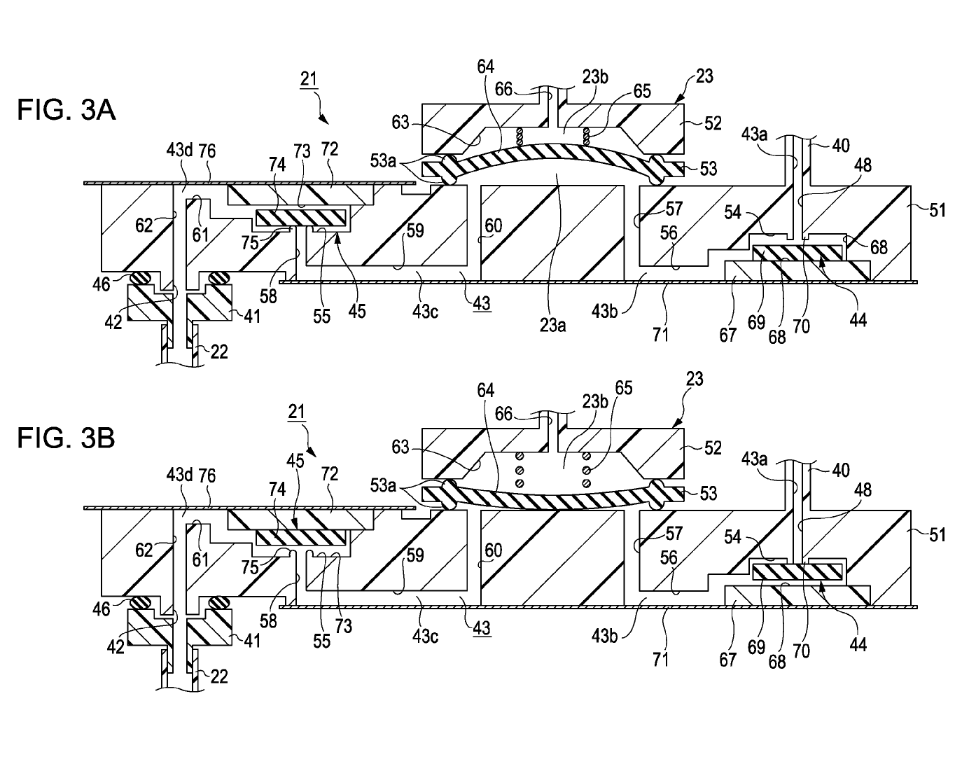

Accordingly, hereinafter, action of the printer 11 configured as described above, more particularly addressed to the action of the ink supply device 21, will be described. FIG. 3A shows a section of the ink supply device at the time of the suction drive. FIG. 3B shows a section of the ink supply device at the time of the discharge drive.

First, the premises are as follows. The state shown in FIG. 2 is a state in which the diaphragm 64 of the pump 23 is being pressed by the elastic force of the coil spring 65 against the upper surface of the first flow channel forming member 51 on the lower side of the diaphragm 64 right after replacement of the ink cartridge. Further, the valve plug 69 of the unidirectional suction valve 44 and the valve plug 74 of the unidirectional discharge valve 45 are located at the valve-closed position. In addition, the air open mechanism 79 is in the valve-closed state in which the air open valve 84 seals up the air open hole 81.

However, when the ink supply device 21 supplies the ink from the ink cartridge C to the printing head unit 20 in the state shown in FIG. 2, first, the drive motor 80 is forwardly driven in order to drive the pump 23. Then, the negative pressure generator 78 creates a negative pressure in the negative pressure chamber 23b of the ink supply device 21 connected to the negative pressure generator 78 through the air flow channel 77. Hence, the diaphragm 64 of the pump 23 is elastically deformed (displaced) toward the negative pressure chamber 23b against the elastic force of the coil spring 65, thereby decreasing the volume of the negative pressure chamber 23b (refer to FIG. 3A). Then, the volume of the pump chamber 23a, which is divided from the negative pressure chamber 23b with the diaphragm 64 interposed therebetween, increases, while the volume of the negative pressure chamber 23b decreases.

That is, the pump 23 performs the suction drive by allowing the diaphragm 64 to be displaced in the direction of increasing the volume of the pump chamber 23a. Specifically, the diaphragm 64 is displaced from the bottom dead point position shown in FIG. 3B to the top dead point position shown in FIG. 3A. Hence, negative pressure is created in the pump chamber 23a, the negative pressure is applied to the valve chamber 68 of the unidirectional suction valve 44 through the second ink flow channel 43b, and the valve plug 69 is moved in a direction of separating from the valve seat 70 by the pressure difference between the ink pressure (the negative pressure) of the valve chamber 68 and the ink pressure (approximately the atmospheric pressure) of the first ink flow channel 43a. As a result, the first ink flow channel 43a communicates with the second ink flow channel 43b, and the ink in the ink cartridge C is suctioned into the pump chamber 23a through the first ink flow channel 43a, the valve chamber 68, and the second ink flow channel 43b.

At the time of the suction drive of the pump 23, the negative pressure within the pump chamber 23a is applied through the third ink flow channel 43c to the third ink flow channel 43c on the downstream side of the pump chamber 23a. However, the negative ink pressure is applied to the valve chamber 73 of the unidirectional discharge valve 45 which communicates with the downstream side of the third ink flow channel 43c. Therefore, the valve plug 74 is in contact with the valve seat 75, and thus the valve-closed state is set to change into the valve-opened state only when a predetermined positive ink discharge pressure (for example, a pressure not less than 13 kPa) is applied by the discharge drive of the pump 23 from the upstream side of the third ink flow channel 43c to the valve plug 74. Accordingly, in this case, since negative pressure is applied to the valve plug 74 of the unidirectional discharge valve 45, the valve plug 74 is maintained in the valve-closed state.

Next, in the state shown in FIG. 3A, the drive motor 80 is reversely driven. Then, the air open valve 84 is opened against the elastic force of the coil spring force 85 by operating the cam mechanism 86 of the air open mechanism 79, and the negative pressure chamber 23b under the negative pressure is opened to the atmosphere. Hence, the diaphragm 64 of the pump 23 is elastically deformed (displaced) downward (that is, toward the inside bottom surface of the pump chamber 23a) by the elastic force of the coil spring 65, thereby increasing the volume of the negative pressure chamber 23b (refer to FIG. 3B). Then, the volume of the pump chamber 23a of the pump 23, which is divided from the negative pressure chamber 23b with the diaphragm 64 interposed therebetween, decreases, while the volume of the negative pressure chamber 23b increases.

That is, the pump 23 performs the discharge drive by allowing the diaphragm 64 to be displaced in the direction of decreasing the volume of the pump chamber 23a. Specifically, as shown in FIG. 3B, the diaphragm 64 is displaced from the top dead point position to the bottom dead point position, and the ink suctioned in the pump chamber 23a is pressurized at a predetermined pressure (For example, a pressure of about 30 kPa). Hence, the ink is discharged from the pump chamber 23a, the discharge pressure is applied to the valve chamber 68 of the unidirectional suction valve 44 through the second ink flow channel 43b on the upstream side of the pump chamber 23a, and the valve plug 69 is moved to come into contact with the valve seat 70. As a result, the first ink flow channel 43a and the second ink flow channel 43b are blocked by closing the valve plug 69 on the suctioning side, thereby stopping suctioning of the ink from the ink cartridge C to the pump chamber 23a through the unidirectional suction valve 44 and regulating the ink, which is discharged from the pump chamber 23a by the discharge drive of the pump 23, to flow back to the ink cartridge C through the unidirectional suction valve 44.

At the time of the discharge drive of the pump 23, the pressure (for example, a pressure of about 30 kPa) of the ink, which is ejected from the pump chamber 23a, is also applied through the third ink flow channel 43c to the downstream side of the ink flow channel 43. Hence, the discharge pressure of the pump 23 opens the valve plug 74, which is in the valve-closed state, on the discharge side, thereby interconnecting the third ink flow channel 43c and the fourth ink flow channel 43d through the valve chamber 73 of the unidirectional discharge valve 45. As a result, the ink is supplied in a pressurized state from the inside of the pump chamber 23a to the valve unit 19 through the third ink flow channel 43c, the valve chamber 73, the fourth ink flow channel 43d, and the ink supply tube 22.

Subsequently, the discharge pressure of the ink, which is pressurized by the diaphragm 64 and is discharged from the pump chamber 23a, is maintained to be applied to the flow channel areas on the downstream side of the valve-closed position of the unidirectional suction valve 44 in the ink flow channel 43. Then, when the ink is ejected from the printing head 18 toward a target (not shown), an amount of the ink, corresponding to the amount of the ink consumed by ejecting the ink, is supplied from the ink flow channel 43 to the printing head unit 20 by opening the self-sealing valve 33. Hence, in accordance with the ink consumption on the downstream side (printing head unit 20 side), the amount of the ink, corresponding to the amount of the consumed ink, is supplied in a pressurized state toward the printing head unit 20 (the downstream side) by the pressing force of the diaphragm 64. The diaphragm 64 is urged by the elastic force of the coil spring 65 in the direction of decreasing the volume of the pump chamber 23a.

As a result, as the volume of the pump chamber 23a gradually decreases, finally the diaphragm 64 is displaced to the vicinity of the bottom dead point position, and the valve plug 74 on the discharge side is moved to the vicinity of the valve-closed position for blocking the fourth ink flow channel 43d. In the embodiment, the discharge pressure of the ink, which is discharged from the pump chamber 23a by the pressing force of the diaphragm 64 at this time, is about 13 kPa.

Then, the drive motor 80 is forwardly driven again, the air open valve 84 in the air open mechanism 79 is displaced to the valve-closed position so as to block the air open hole 81, the negative pressure generator 78 creates a negative pressure so as to negatively pressurize the negative pressure chamber 23b, the diaphragm 64 is elastically deformed (displaced) toward the negative pressure chamber 23b against the elastic force of the coil spring 65. That is, the pump 23 starts the suction drive again. As a result, the diaphragm 64 is displaced to the top dead point position in order to increase the volume of the pump chamber 23a, thereby creating the negative pressure in the pump chamber 23a. Hence, the valve plug 69 on the suctioning side is moved by the effect of the negative pressure in the valve-opened direction, and is separated from the valve seat 70. Accordingly, the first ink flow channel 43a and the second ink flow channel 43b communicate with each other through the valve chamber 68 of the unidirectional suction valve 44, and the ink is suctioned from the inside of the ink cartridge C into the pump chamber 23a again. Then, the discharge drive of the pump 23 the same as the above is executed, thereby supplying the ink in a pressurized state from the inside of the pump chamber 23a to the printing head unit 20 through the ink flow channel area on the downstream side.

However, in the printer 11, bubbles may enter into the printing head 18 through the nozzle 29, and gases such as air, which permeate through the ink supply tube 22 made of synthetic resin and are dissolved in the ink, may increase bubbles in the ink. In addition, the bubbles mixed in the ink tend to stay in large spaces such as the chambers of the buffer 32 and the self-sealing valve 33 provided in the path of the ink flow channel 30. Subsequently, if the bubbles remain untouched, the largely increased bubbles flow into the nozzles 29. This causes an ejection error. In addition, dust attachment and solidification or an increase in the viscosity of the ink due to evaporation of ink solvent from the nozzle 29 may cause the nozzles to become clogged. In such a case, the inside of the printing head 18 is suctioned by closing the choke valve 31 provided in the path of the ink flow channel 30, and the choke valve 31 is opened when the negative pressure reaches a certain level, thereby performing so-called choke cleaning for suctioning and removing the thickened ink mixed with bubbles from the inside of the printing head 18 in a short time. In the printer 11 according to the embodiment, such a choke cleaning is executed as follows.

Specifically, in the state shown in FIG. 2, the cap 26 is brought into contact with the nozzle formation surface 18a of the printing head 18 so as to enclose the nozzle 29, and the suction pump 35 is driven in this state. Then, a negative pressure is created in the cap 26 which is in contact with the nozzle formation surface 18a of the printing head 18. Hence, the suction force based on the negative pressure is applied to the nozzle 29, thereby suctioning the inside of the ink flow channel 30 through the nozzle 29. At this time, in the choke valve 31, since the negative pressure is applied to the ink chamber 115 through the ink flow channel 30, the film 114 is deformed by the differential pressure between the ink pressure (the negative pressure) and the atmospheric pressure so as to be concave toward the ink chamber 115 and comes into contact with the upper end surface of the tube portion 103 so as to block the opening. As a result, the choke valve 31 is closed.

Next, the drive motor 80 is forwardly driven, and the pump 23 performs the suction drive accompanied with the drive of the negative pressure generator 78. Accordingly, the valve plug 69 of the unidirectional suction valve 44 is opened, thereby suctioning the ink from the ink cartridge C into the pump chamber 23a. Then, the volume of the pump chamber 23a is increased by displacement of the diaphragm 64 to the top dead point position, thereby suctioning the ink. Subsequently, the drive motor 80 is reversely driven. Then, the air open mechanism 79 opens the air open valve 84, thereby releasing the negative pressure state of the negative pressure chamber 23b. Hence, the diaphragm 64 is urged by the elastic force of the coil spring 65 in the direction of decreasing the volume of the pump chamber 23a, thereby discharging the ink with an ink discharge pressure of, for example, about 30 kPa from the inside of the pump chamber 23a.

As a result, the valve plug 69 of the unidirectional suction valve 44 is closed, and the valve plug 74 of the unidirectional discharge valve 45 is opened. Then, the pressurized ink discharged from the inside of the pump chamber 23a is supplied in a pressurized state to the downstream side of the unidirectional discharge valve 45. As a result, the pressure within the ink chamber 115 is increased by supplying the pressurized ink to the ink chamber 115 of the choke valve 31. Hence, the film 114 of the choke valve 31 is separated from the tube portion 103, thereby opening the choke valve 31. In addition, the negative pressure within the downstream area of the choke valve 31 is sufficiently high at this point in time. In this stage, the choke valve 31 is opened for a short period of time from a state where the pressurized ink is supplied to the upstream side of the choke valve 31. Hence, the ink on the upstream side of the choke valve 31 swiftly flows through the ink flow channel 30, and is suctioned and discharged from the nozzle 29 of the printing head 18. As a result, the ink thickened and solidified in the nozzle 29, dust such as paper particles mixed in the ink, and the ink mixed with bubbles remaining in the ink flow channel 30 are discharged from the nozzle 29 into the cap 26 in a short period of time. Then, the waste ink discharged into the cap 26 is additionally discharged into the waste tank 36.

In this case, the unidirectional suction valve 44 of the upstream side of the pump chamber 23a is closed. Therefore, even when the ink swiftly flows toward the printing head 18 by opening the choke valve 31, the ink is not discharged from the upstream side of the unidirectional suction valve 44 toward the printing head 18. Hence, in the printer 11 according to the embodiment, it is possible to perform the choke cleaning while suppressing heavy consumption of the ink in the ink cartridge C.

In the choke cleaning, the ink flows swiftly in the downstream area in which the negative pressure is maintained until that moment by opening the choke valve 31 quickly, thereby filling the downstream area with the ink. Accordingly, swift outflow of the ink is buffered. An ink outflow amount Vᵢₙₖ after opening the choke valve 31 is approximately equal to the sum of a volume V1 of the ink flow channel (which includes the ink storage chamber 117 of the buffer 32, the ink chamber 124 of the self-sealing valve 33, the pressure chamber 123, and the like) from the choke valve 31 to the nozzle 29 and a volume V2 of the cap 26 (Vink−V1+V2).

In the embodiment, the choke valve 31 is provided in the printing head unit 20, and thus the buffer 32 is provided downstream of the choke valve 31, thereby increasing the volume by the volume of the buffer 32. However, the volume V1 in the range from the choke valve 31 to the nozzle 29 relatively decreases. For example, the choke valve may be provided in the ink supply device used as the cartridge holder. In this configuration, the volume of the flow channel in the ink supply tube 22 is added to the volume of the ink flow channel from the choke valve to the nozzle, and thus the volume greatly increases. Specifically, the ink supply tube 22 is dragged and turned with a length which is sufficient for following the carriage 15 even when the carriage 15 reciprocates in the range of the maximum paper width in the main scanning direction. In addition, the length of the tube is set to be much longer than that of the flow channel of the ink flow channel 30 of the printing head unit 20.

In the configuration according to the embodiment, the ink outflow amount Vink may be relatively small. In this point of view, the ink outflow amount Vink is set to be smaller than the ink discharge amount Vpump which can be discharged by allowing the pump 23 to perform the single discharge drive. Hence, it is possible to continue the single discharge drive until the whole of the downstream area, in which the negative pressure is created, is filled with the pressurized ink after the discharge of the pressurized ink is started in the choke cleaning by starting the discharge drive of the pump 23. For example, in the intermediate stage in which the ink outflow amount Vink of the ink is about to flow out, the single discharge drive of the pump 23 may be terminated. In this case, the pressure supply of the ink is discontinued. Therefore, the ink flows out only by a force of the negative pressure within the downstream area, and a speed of the outflow of the ink is lowered. As a result, the ink outflow after the termination of the single discharge drive of the pump 23 is not effectively used for the cleaning.

Further, the choke cleaning may be intermittently performed by the following method: first, applying of the suction force to the nozzle 29 is stopped during the suction drive of the pump after the termination of the single discharge drive of the pump, and then the suction force is applied to the nozzle 29 again when the second discharge drive is started. However, in this case, incomplete ink outflow operations are performed twice. Therefore, it is difficult to perform effective cleaning, and also a lot of the ink is wastefully discharged.

Accordingly, in the configuration according to the embodiment, the discharge drive of the pump 23 is able to continue until the ink outflow amount Vink of the ink completely flows out. Therefore, all the outflow ink can be effectively used in the cleaning.

The unidirectional discharge valve of the ink supply device may be used as the choke valve, and it may be possible to adopt a choke valve having a valve structure in which the valve plug is urged by a spring so that the unidirectional discharge valve is perfectly closed. However, the choke valve having the valve structure in which the valve plug is urged by the spring is closed by a predetermined pressure based on balance between the elastic force of the spring and the pressure of the pressure chamber. That is, the choke valve is not closed until the predetermined pressure is reached. Hence, during the printing, when the discharge drive of the pump 23 is turned into the suction drive, the choke valve used as the unidirectional discharge valve is closed after the predetermined pressure is reached. Therefore, the ink pressure within the downstream area of the unidirectional discharge valve (the choke valve) is lowered to the vicinity of the atmospheric pressure by delay of the valve closing.

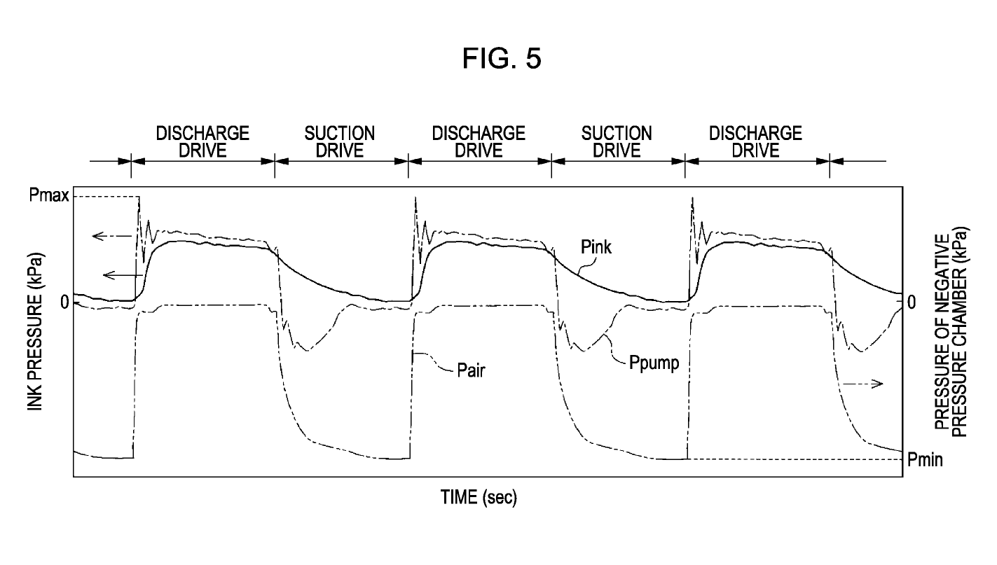

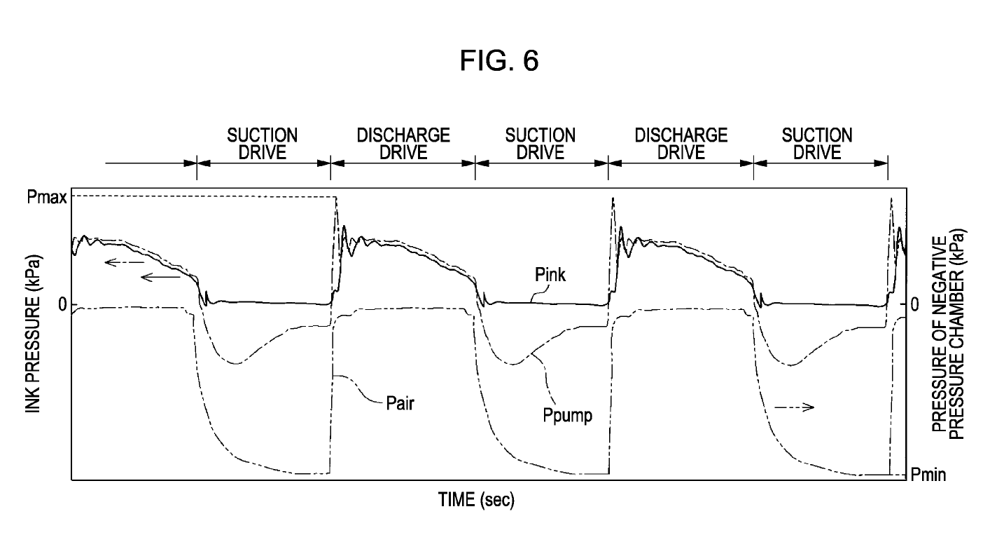

FIG. 5 is a graph illustrating time-series variation of the ink pressure accompanied with the pump drive during the printing. FIG. 6 is graph illustrating time-series variation of the ink pressure accompanied with the pump drive during the printing in a configuration, in which the spring type unidirectional discharge valve is used as the choke valve, as a comparative example. In the graphs of FIGS. 5 and 6, the chain double-dashed line indicates variation in a pressure Pair within the negative pressure chamber 23b of the pump 23, the chain line indicates variation in the ink pressure Ppump within the pump chamber 23a of the pump 23, and the solid line indicates variation in the ink pressure Pink within the downstream area of the choke valve. In addition, in the graphs of FIGS. 5 and 6, the horizontal axis represents time (sec), the vertical axis represents the Pink, the Ppump represents the ink pressure, and the Pair represents air pressure. Furthermore, the horizontal axis represents a relative pressure when the atmospheric pressure is set to “0”.

During the printing, the pump 23 repeatedly performs the suction drive and the discharge drive, and thus supplies the ink pressurized at a predetermined pressure (a positive pressure) in the process of the discharge drive of the pump 23 of those. As shown in the graph of FIG. 5, the pressure Pair (hereinafter, it is referred to as the “pressure within negative pressure chamber Pair”) within the negative pressure chamber 23b is lowered to the minimum pressure Pmin of the negative pressure at the time of the suction drive of the pump 23. When the suction drive of the pump 23 is turned into the discharge drive, the pressure within negative pressure chamber Pair is increased from the minimum negative pressure Pmin to the maximum positive pressure Pmax. The ink supply pressure is maintained at a required positive pressure while the ink is consumed in the period of the discharge drive of the pump 23.

FIG. 5 shows the case where the choke valve 31 is the non-spring type (flexible film type) differential pressure regulating valve in which the film 114 (diaphragm) is not urged by a spring. In this case, when the discharge drive of the pump 23 is turned into the suction drive, the diaphragm 64 is displaced upward in accordance with the lowering of the pressure Pair of the negative pressure chamber 23b. Hence, the ink pressure Ppump of the pump chamber 23a is lowered. As a result, the unidirectional discharge valve 45 and choke valve 31 are closed. At this time, although the valve closing of the unidirectional discharge valve 45 is delayed, the choke valve 31 is closed in direct response to the start of the lowering of the ink pressure of the ink chamber 115. Hence, the ink pressure Pink within the downstream area of the choke valve 31 is not greatly lowered from the ink pressure at the time of the pump discharge drive.

FIG. 6 shows the case where the choke valve is the spring type differential pressure regulating valve used as the unidirectional discharge valve. In this case, when the discharge drive of the pump is turned into the suction drive, the ink pressure Ppump of the pump chamber is lowered in accordance with the lowering of the pressure Pair of the negative pressure chamber. As a result, the unidirectional discharge valve, that is, the choke valve is closed. At this time, the unidirectional discharge valve (the choke valve) is completely closed at the time point when the ink pressure Ppump of the pump chamber is lowered to a set pressure (a predetermined positive pressure lower than the ink supply pressure in the process of the discharge drive). Therefore, the ink pressure Pink within the downstream area of the choke valve is lowered in accordance with the lowering of the ink pressure Ppump within the pump chamber accompanied with the suction drive until the valve is closed. As a result, in the case of the comparative example of FIG. 6, the ink pressure Pink within the downstream area of the choke valve is lowered to near atmospheric pressure (0 kPa). The ink pressure Pink within the downstream area of the choke valve is lowered, and then the ink pressure of the ink stored in the buffer 32 is lowered to near atmospheric pressure. Thus, the ink pressure of the ink chamber 124 of the self-sealing valve 33 is lowered to near atmospheric pressure. Then, the ink of the printing head 18 starts to be consumed during the pump suction drive with the ink within the buffer 32 lowered to near atmospheric pressure, and whenever the printing head 18 is replenished with the ink by opening the self-sealing valve, the amount of the ink within the buffer 32 decreases, and the ink pressure is gradually lowered. As described above, when the initial ink pressure of the buffer 32 is low at the time of starting the pump suction drive, the ink pressure of the buffer 32, supplied with a predetermined amount of the ink, is greatly lowered as compared with the case where a high initial pressure can be maintained. Thus, the ink pressure of the ink chamber is greatly lowered at the time of finally opening the self-sealing valve during the process of the pump suctioning. Hence, a problem may arise in that the self-sealing valve is not opened unless the ink pressure within the pressure chamber becomes smaller than that in the normal valve-opened state when the timing is mismatched to open and close the self-sealing valve. In this case, the ink with an ink pressure lower than the normal pressure is supplied through the ink flow channel of the printing head. Hence, for example, sizes (a liquid volume) of the ink droplets ejected from the nozzle of the printing head may become smaller than an appropriate size. This causes a problem in that extremely small sized ink dots are formed on a target (for example, paper).

In contrast, the choke valve 31 according to the embodiment is opened and closed only by the ink pressure applied to the flexible film 114 as the non-spring type differential pressure regulating valve. Hence, when the discharge drive of the pump 23 is turned into the suction drive, the choke valve 31 is immediately closes when the ink pressure Pink starts to be lowered in the process of closing the unidirectional discharge valve 45. Accordingly, as shown in the graph of FIG. 5, the ink pressure Pink within the downstream area of the choke valve is maintained at a relatively high ink pressure by immediately closing the choke valve 31 when the ink pressure Ppump initially begins to lower, even when the ink pressure Ppump of the pump chamber 23a lowers quickly by the turning into the suction drive of the pump 23. As a result, the ink chamber 124 of the self-sealing valve 33 is maintained at relatively high ink pressure Pink, and in this state, the ink in the printing head 18 is continuously consumed. Then, when the self-sealing valve 33 is opened in order to replenish the ink, the ink with the appropriate ink pressure is supplied to the ink flow channel 97 close to the printing head 18. Hence, even in the period of the pump suction drive, the ink droplets with the appropriate sizes (the liquid volume) are ejected from the nozzle 29 of the printing head 18, and appropriately sized ink dots are formed on the target (for example, the paper). Accordingly, the printer 11 performs high quality printing.

In the embodiment, the unidirectional suction valve 44 and the unidirectional discharge valve 45 are not a spring type, but adopt the valve structure in which the valve is closed by suctioning and attracting the valve plugs 69 and 74 based on the inflow pressure of the ink flowing in the central openings of the valve seats 70 and 75. Hence, the discharge drive of the pump 23 is turned into the suction drive, the ink in the valve chamber 73 starts to flow in the central opening of the valve seat 75, and then the valve plug 74, which is attracted by the inflow pressure, comes into contact with the valve seat 75, thereby relatively promptly closing the unidirectional discharge valve 45. As a result, the ink pressure within the downstream area of the unidirectional discharge valve 45 can be maintained at a relatively high level.

In the embodiment, since the buffer 32 is provided downstream of the choke valve 31 in the printing head unit 20, the following effects can be obtained. For example, in the case where the printer 11 is a large size printer, the paper width greatly increases, and thus the ink amount, which is ejected by the single scanning of the printing head 18, greatly increases. Further, although the printer 11 is not a large size printer, the ink amount, which is ejected by the single scanning of the printing head 18, greatly increases when the printer 11 performs solid printing and the like.

As described above, during the printing in which a large amount of the ink is ejected for each single scanning, a large amount of the ink is consumed during the discontinuance of the ink supply due to the suction drive of the pump 23. However, in this example, the ink, which is stored in the buffer 32 in the process of the discharge drive of the pump 23, is supplied to the printing head 18 through the self-sealing valve 33 in the process of the suction drive of the pump 23. Accordingly, even in the period, in which the ink supply is discontinued, as the period of the suction drive of the pump 23, the ink to be supplied to the printing head 18 is not likely to be insufficient. Hence, it is possible to continue the printing.

Here, in the process of the discharge drive of the pump 23, the pressurized ink is stored in the ink storage chamber 117 of the buffer 32, and the film 116 is swelled outward (toward air) as shown in FIG. 4. Then, after the turning into the suction drive of the pump 23, the ink pressure Pink within the downstream area is maintained at a relatively high level by closing the choke valve 31 as described above. Therefore, the pressurized ink is stored in the buffer 32.

Here, the self-sealing valve 33 is configured so that the film 118 is urged outward (toward the outside of the chamber) by the spring 121 with the valve plug 119 interposed therebetween. Therefore, the ink pressure within the pressure chamber 123 is maintained at a negative pressure which is slightly lower than the atmospheric pressure. Then, as the ink in the printing head 18 is continuously consumed by ejecting the ink droplets from the nozzle 29, the ink within the pressure chamber 123 of the self-sealing valve 33 gradually decreases. Then, the film 118 (the diaphragm) is deformed so as to be concave toward the pressure chamber 123 against the elastic force of the spring 121, and presses the valve plug 119, thereby opening the self-sealing valve 33. By opening the valve, the ink flows from the ink chamber 124 with a high pressure into the pressure chamber 123 with a low pressure through the communicating hole 102, and the ink flow channel 97 close to the printing head 18 is replenished with the ink depressurized in the pressure chamber 123.

When printing under the condition in which the amount of ejected ink for the single scanning is large, the ink within the buffer 32 is rapidly consumed in the period of the suction drive of the pump 23, and the film 116, which is swelled outward until that moment, is subsequently planarized, and is made to be concave toward the ink storage chamber 117. At this time, a restorative force (a force in the direction of increasing the chamber volume), which restores the film 116 to the originally flat state, is applied to the ink in the ink storage chamber 117, thereby depressurizing the ink by that extent. However, the restorative force of the film 116 in the non-spring type buffer 32 is excessively smaller than that of the spring type buffer in which the film is urged outward by the coil spring, and thus is negligible. Therefore, the restorative force of the film 116 has infinitesimally small influence on depressurization of the ink. Accordingly, even when the ink in the buffer 32 is consumed until the film 116 is deformed to be concave inward, the ink pressure is maintained to be not less than a required amount higher than the head supply pressure. As a result, the ink pressure within the ink chamber 124 of the self-sealing valve 33 is maintained to be not less than the required amount higher than the ink pressure (that is, the head supply pressure) of the pressure chamber 123. Accordingly, the self-sealing valve 33 is opened when the pressure chamber 123 reaches the set pressure, and the pressure chamber 123 is replenished with the ink from the ink chamber 124. Therefore, the ink pressure within the printing head 18 is maintained at the set pressure (the head supply pressure). As a result, it is possible to avoid the occurrence of ejection errors, such as non-ejection of the ink droplets and ejection of extremely small sized ink droplets caused by the ink supply pressure to the printing head being lower than the set pressure.

For example, although the ink storage chamber exists in the path of the ink flow channel close to the printing head unit, it may be the spring type ink storage chamber in which the flexible film (diaphragm) is urged outward by the spring, or may be the ink storage chamber which is enclosed by walls in all directions only by expanding the flow channel. In this case, when the ink is continuously consumed, the ink in the ink storage chamber is depressurized to a considerable negative pressure. Then, when the ink pressure applied to the ink chamber of the self-sealing valve becomes not more than, for example, the head supply pressure, the self-sealing valve is not opened at the appropriate pressure, or although the valve is opened, the pressure difference between the ink chamber and the pressure chamber is extremely small. Hence, the replenishment of the ink to the printing head becomes incomplete. For example, the ink replenishment speed may be lowered, and the ink may not be replenished. In contrast, in the buffer 32 according to the embodiment, the film 116 may be deformed toward the inward (toward the inside of the chamber) by decreasing the amount of the ink in the ink storage chamber 117. Even in this case, since the restorative force, which is applied to the film 116 and is deformed inward, is extremely small, the ink in the buffer 32 may be slightly depressurized, and the ink pressure in the range from the buffer 32 to the ink chamber 124 of the self-sealing valve 33 is maintained to be not less than the required pressure. Hence, the self-sealing valve 33 is opened when the pressure within the pressure chamber 123 is in the range of the set pressure. As a result, it is possible to perform the ink supply to the printing head 18 while maintaining an appropriate ink pressure within the printing head 18.

In addition, the buffer 32 is provided on the downstream side of the choke valve 31 provided in the printing head unit 20. Therefore, the ink with the high ink pressure Pink within the choke valve downstream area can be stored in the ink storage chamber, and the length of the flow channel from the buffer 32 to the nozzle 29 may be relatively short. In these points, pressure loss in the flow channel from the buffer 32 to the nozzle 29 is relatively small. As a result, it is possible to maintain the supply pressure required for supplying the ink to the nozzle 29 in the printing head 18.

As described above, according to the embodiment, the following advantages can be obtained.

1. The choke valve 31 is provided in the printing head unit 20. Therefore, the volume of the buffer 32 provided on the downstream side increases, but it is possible to make the volume V1 of the flow channel from the choke valve 31 to the nozzle 29 relatively small. Hence, the ink outflow amount Vink at the time of the choke cleaning is made to be smaller than the ink discharge amount Vpump which can be discharged for the single discharge drive of the pump 23. Thus, since the pressurized ink completely flows throughout the downstream area in a short period of time, in which the negative pressure is created, in the period from the start to the end of the single discharge drive of the pump 23, it is possible to complete the choke cleaning. Hence, the choke cleaning is not completed by the single discharge drive of the pump, and it is possible to avoid the discontinuance of the choke cleaning caused by turning into the suction drive of the pump. As a result, it is possible to continue the discharge drive of the pump 23 until the ink outflow amount Vink of the ink completely flows out, and thus it is possible to effectively use all the outflow ink for the cleaning.

2. The non-spring type differential pressure regulating valve having the flexible film 114 is employed as the choke valve 31. Therefore, the ink pressure starts to be lowered from the discharge drive pressure by turning the discharge drive of the pump 23 into the suction drive, and the choke valve 31 is directly closed. Accordingly, it is possible to maintain the ink pressure Pink within the downstream area of the choke valve 31 at a relatively high level without significant lowering. Hence, it is possible to supply the ink with an appropriate pressure toward the printing head 18 when the self-sealing valve 33 is opened during the process of the pump suction drive without greatly lowering the pressure of the ink chamber 124 of the self-sealing valve 33. For example, the spring type unidirectional discharge valve of the ink supply device may be used as the choke valve. In this case, problems arise in that the delay in the closing of the valve of the choke valve occurs after the ink pressure starts to lower at the time of turning into the suction drive of the pump, and the ink pressure Pink within the downstream area of the choke valve is lowered to near atmospheric pressure. These problems cause an error in that extremely small sized ink droplets are ejected from the nozzle of the printing head. However, when the choke valve 31 according to the embodiment is used, it is possible to eliminate this error of extremely small sized ink drops being ejected.

3. The buffer 32 is provided in the printing head unit 20. Therefore, the ink stored in the buffer 32 is supplied during the printing under the condition, in which an amount of ejected ink for the single scanning is large, in the period of the discontinuance of the ink supply caused by the suction drive of the pump 23. Thus, it is possible to avoid a shortage in the ink to be ejected from the nozzle 29 of the printing head 18. As a result, it is possible to prevent printing errors caused by the shortage of the ink to be ejected at the time of the solid printing from occurring, for example, regardless of whether the printer 11 is a large sized printer or not.

4. The buffer 32 is a non-spring type having the flexible film 116 as a part of a member for partitioning the ink storage chamber 117. Therefore, it is possible to maintain the ink pressure at a level not less than the atmospheric pressure even when the ink amount in the ink storage chamber 117 (the ink chamber) decreases due to ink consumption. Accordingly, when the ink supply is discontinued for the suction drive of the pump 23, it is possible to supply the ink toward the printing head 18 with the ink pressure, which is not less than the required pressure, even when the ink is continuously consumed. For example, it may be possible to use the ink storage chamber, which is formed by expanding walls of the flow channel, and the spring type ink storage chamber which is partitioned by the flexible film urged outward (toward the outside of the chamber) by a spring. In this case, when the amount of the ink in the chamber is decreased by the ink consumption, depressurization progresses in accordance with the decrease in the ink amount, and the ink pressure within the chamber is depressurized to, for example, a pressure less than the atmospheric pressure (a negative pressure). In this case, the ink pressure within the printing head is remarkably lowered, and this causes ejection errors such as non-ejection of the ink droplets and ejection of extremely small sized ink droplets. However, by using the buffer 32 according to the embodiment, it is possible to avoid such excessive depressurization of the ink within the printing head 18. Therefore, it is possible to stably perform normal ejection of the ink droplets.

5. The self-sealing valve 33 is provided as the spring type differential pressure regulating valve in which the valve plug is urged by a spring and which is opened to replenish the amount of the ink consumed by the ejection from the nozzle 29, in the path of the ink flow channel 93 between the choke valve 31 and the nozzle 29 in the printing head unit 20. As a result, it is possible to replenish the printing head 18 with the ink at an appropriate ink pressure.

6. The choke valve 31, the buffer 32, and the self-sealing valve 33 (the spring type differential pressure regulating valve) are provided in order from the upstream side of the ink flow channel 93 toward the printing head unit 20. Hence, at the time of the choke cleaning, it is possible to discharge the bubbles collected in the chambers of the buffer 32 and the self-sealing valve 33. Specifically, a negative pressure is created in the chambers of the buffer 32 and self-sealing valve 33 by applying the suction force from the nozzle 29 to the chambers, whereby the small bubbles mixed in the ink in the chambers grow as large bubbles, and thus the bubbles become large, thereby improving discharge ability of the bubbles at the time of the choke cleaning. As a result, it is possible to avoid the ejection errors such as dot loss caused when the ink is not ejected and lack in ink droplet size caused by the bubbles which have flowed from the chambers of the buffer 32 and the self-sealing valve 33 to the nozzle 29.

7. The unidirectional discharge valve 45 in the ink supply device 21 is provided as the non-spring type valve structure. In the structure, the valve is closed in a way that the valve plug 74 is attracted by the inflow ink, which flows in the central opening of the valve seat 75, so as to come into contact with the valve seat 75. Hence, when the pump chamber 23a starts to be depressurized in accordance with the turning into the suction drive of the pump 23, the unidirectional discharge valve 45 is promptly closed. Therefore, the ink pressure within the downstream area may not be greatly lowered. Furthermore, the unidirectional suction valve 44 has the same non-spring type valve structure. Therefore, even when the ink pressure of the pump chamber 23a is raised at the time of the discharge drive of the pump 23, and the valve is promptly closed. Thus, it is possible to effectively prevent flow back of the ink to the ink cartridge C. Further, the valve structure has a simple configuration in which the valve plugs 69 and 74 made of rubber pieces are housed in the valve chambers 68 and 73. Therefore, the number of components in the unidirectional valves 44 and 45 can be decreased, and the production thereof is also simple. Thus, it is possible to form the ink supply device 21 with a relatively simple configuration.

8. The buffer 32 is provided in the printing head 20, and thus is not required to be connected to the flexible ink supply tube 22. Hence, it is possible to prevent the lowering of the inner pressure within the buffer 32 caused by the pressure loss of the ink in the ink supply tube 22, and thus it is possible to maintain the ink pressure within the buffer 32 at a relatively high level. Further, since the buffer 32 is provided in the printing head 20, the length of the flow channel from the buffer 32 to the nozzle 29 is made to be relatively short. Therefore, it is possible to apply the ink supply pressure within the buffer 32 to the ink chamber 124 of the self-sealing valve 33 without greatly lowering the ink pressure due to pressure loss.

9. The ink stored in the buffer 32, which is provided in the printing head unit 20, is configured to be supplied to the printing head 18. Hence, for example, even when the detection section detects that the ink within the ink cartridge C has run out (vacancy) during the printing, it is possible to complete the printing. In particular, when printing is performed on a roll paper, it is possible to complete the printing even when the ink runs out during the printing without determining whether or not the ink will run out before starting the printing or during the printing. Hence, it is possible to avoid the problems such as a change in color tone caused at the discontinued location when the printing is discontinued in mid-course. For example, after a screen display of a host device, lighting of a lamp, or the like, notifies that the ink has run out, the printing is continued for a while, for example, for several minutes (two to five minutes) by using the ink supplied from the buffer 32. Therefore, it is possible to replace the ink cartridge during the printing.

The embodiment is not limited to the above, and may be modified in the following forms.

Modified Example 1: In the above-mentioned embodiment, the non-spring type differential pressure regulating valve is employed as the choke valve, but the spring type differential pressure regulating valve may be employed. Furthermore, an electronic valve may be employed as the choke valve. Even in these configurations, when the choke valve is provided in the printing head unit, and when the choke cleaning is made to be completed by the single discharge drive of the pump 23, it is possible to perform effective choke cleaning without wasting the ink.

Modified Example 2: The buffer 32 may be removed. If only the ink can be supplied without the event of the ink running out even in the period of the suction drive of the pump 23, the buffer 32 may be removed. In the configuration without the buffer 32, it is preferred that the ink outflow amount Vink be less than the ink discharge amount Vpump which can be supplied by the single discharge drive of the pump 23, and thus it is also possible to obtain the effect that the choke cleaning is completed by the single discharge drive of the pump 23.

Modified Example 3: The pump is not limited to the diaphragm type pump, and the pulsation type pump that performs the suction drive and the discharge drive may be employed. For example, a bellows type pump (an accordion type pump) or a piston type pump may be employed. Even in this case, by satisfying the condition of ink outflow amount Vink<ink discharge amount Vpump, the choke cleaning is completed by the single discharge drive of the pump, and thus it is possible to perform effective choke cleaning.

Modified Example 4: In the above-mentioned embodiment, the choke valve is closed by the suction force applied to the nozzle, but it may be possible to adopt the configuration in which the suction force is applied to the nozzle after the choke valve is closed by performing the suction drive of the pump 23. In this case, it is possible to avoid wasteful discharge of the ink, which is likely to occur in the case of the configuration according to the embodiment, until the choke valve is closed.

Modified Example 5: In the above-mentioned embodiment, the self-sealing valve 33 is provided as the liquid replenishing mechanism for replenishing the printing head with the ink by depressurizing the ink to the ink pressure required for the printing head. However, as the liquid replenishing mechanism, it may be possible to employ the depressurization mechanism configured so that, for example, the opening of the ink storage chamber casing as disclosed in the Japanese Unexamined Patent Application Publication No. 2006-272661 is blocked by the flexible film, and the spring for urging the film outward is housed in the chamber.

Modified Example 6: In the above-mentioned embodiment, the ink supply device is used as the cartridge holder, and is formed separately from the printing head unit 20. However, as described in Japanese Unexamined Patent Application Publication No. 2006-272661, it may be possible to adopt the configuration in which the ink supply device having the pump and the pair of unidirectional valves is mounted in the printing head unit 20. In this case, the choke valve 31 and the buffer 32 are provided downstream of the unidirectional discharge valve of the ink supply device in the printing head unit. It is apparent that the unidirectional discharge valve may be used as the choke valve. Even in this configuration, a pump size (a discharge volume), a flow channel size (a flow channel length and a flow channel diameter which determines a flow channel volume), and a cap size (a cap volume) are determined so as to satisfy the condition of ink outflow amount Vink<ink discharge amount Vpump. As a result, it is possible to complete the choke cleaning by performing the single discharge drive of the pump 23, and thus it is possible to perform effective choke cleaning while scarcely wasting the ink.

Modified Example 7: In the above-mentioned embodiment, the ink jet type serial printer is employed, but the ink jet type line printer may also be employed. In the case of the line printer, for example, the printing head unit is a fixed type which can be moved only upward and downward (the Z direction) so as to adjust the platen gap, and is unable to be moved in a horizontal direction (the XY direction).

Modified Example 8: In the above-mentioned embodiment, the ink jet type printer and the ink cartridge are employed, but the liquid ejecting apparatus, which ejects or discharges liquid other than ink, and the liquid container, which contains the liquid, may be employed. Those can be applied to various liquid ejecting apparatuses having the liquid ejecting head for discharging infinitesimally small amounts of liquid droplets. Furthermore, the liquid droplets mean a state of the liquid discharged from the liquid ejecting apparatus, that is, the liquid droplets are defined to include droplets having a granular shape, a tear shape, and a thread shape as a trailing shape. Further, the liquid described herein may be any material if only the material can be ejected by the liquid ejecting apparatus. For example, any material in a liquid state may be used, and the material may include not only liquid, which is one state of substance, such as liquid substance having high or low viscosity, sol, gel water, other inorganic solvents, organic solvents, solution, fluid like resin, and fluid like liquid metal (metallic melt), but also the material in which particles of a functional material formed of solids such as pigments and metallic particles are dissolved, distributed, or mixed in a solvent. Further, representative examples of the liquid include the ink as described in the embodiment and a liquid crystal. Here, the ink is defined to include various liquid composites such as general water-based and oil-based inks, a gel ink, and a hot-melt ink. The detailed examples of the liquid ejecting apparatus include a liquid ejecting apparatus for ejecting liquids including materials, in a distributed or dissolved form, such as color materials and electrode materials used for production of a liquid crystal display, an EL (electroluminescence) display, a surface-emitting display, and a color filter; a liquid ejecting apparatus for ejecting bio organic materials used in bio chip production; a liquid ejecting apparatus, which is used as a precision pipette, for ejecting liquids as specimens; a textile printing apparatus; and a micro dispenser. Moreover, it may be possible to employ a liquid ejecting apparatus for ejecting lubricating oil to precision instruments such as a clock and a camera by using a pin point method; a liquid ejecting apparatus for ejecting transparent resin liquid such as ultraviolet curable resin on a substrate in order to form a micro hemispherical lens (optical lens) used in an optical communication element; and a liquid ejecting apparatus for ejecting etching liquid such as acid or alkali in order to perform an etching on a substrate and the like. The invention may be applied to any one of the liquid ejecting apparatuses and the liquid containers.

Modified Example 9: The choke valve and the buffer may not be entirely provided in the printing head unit. If only the choke valve and the buffer are entirely provided on the downstream side of the unidirectional discharge valve, this configuration may be adopted. For example, the buffer may be provided in the path of the ink supply tube 22. Further, for example, the choke valve may be provided at a position in the path of the ink supply tube 22 or a position downstream of the unidirectional discharge valve 45 in the ink supply device 21. In the combination of the positions of the choke valve and the buffer, when the choke valve is provided in the ink supply device, the buffer may be provided at the position in the path of the ink supply tube (the pipe line) or in the printing head unit. Further, when the choke valve is provided at a position in the path of the ink supply tube (the pipe line), the buffer may be provided in the printing head unit or at the position in the path of the ink supply tube on the downstream side of the choke valve. Furthermore, it may be possible to adopt the configuration in which the unidirectional discharge valve (the second unidirectional valve) is used as the choke valve. In this case, the spring type choke valve may be employed. In these cases, since a volume of the flow channel from the choke valve to the nozzle increases in accordance with the position of the choke valve, it may be possible to adopt the configuration in which the single choke cleaning is performed by the plurality of discharge drives of the pump 23. Even in this configuration, since the buffer 32 exists, it is possible to continue the printing without discontinuance caused by ink shortage in that the ink stored in the buffer 32 can be supplied to the printing head 18 in the portion of the suction drive of the pump.

Modified Example 10: The buffer is not limited to the configuration in which the flexible film is thermally adhered so as to liquid-tightly block the opening of the recessed portion. For example, it may be possible to adopt a configuration in which two flexible film are fixed so as to respectively block, in a liquid-tight state, both openings of the holes formed through the member. Furthermore, the buffer chamber may be formed as a sac-like pack which is formed of only a flexible member such as a film and has an inlet and an outlet. In this case, it may be possible to adopt the configuration in which the supply pipe portion is connected to the inlet of the sac-like pack and the discharge pipe portion is connected to the outlet. Further, the flexible member is not limited to the film, but may be a deformable form such as a sheet. Furthermore, the material of the flexible member is not limited to a laminate film of a metallic film and a synthetic resin, and only a synthetic resin, a metal, a ceramic, and a combination material of at least two of these three materials may be employed.

Modified Example 11: An urging section may be provided which urges the flexible film constituting the buffer toward the ink storage chamber. For example, it may be possible to adopt a configuration in which one end of the coil spring is brought into contact with the pressure receiving plate attached to the center of the flexible member (the diaphragm) such as the film from the outside, and the flexible member (the diaphragm) is pressed toward the ink storage chamber. In this configuration, it is possible to maintain the ink pressure within the buffer chamber at a positive pressure by the elastic force of the urging section. Therefore, even when the ink in the buffer greatly decreases, it is possible to apply the supply pressure not less than the required pressure to the ink chamber of the self-sealing valve.

Technical spirits according to the embodiments and the modified examples will be described as follows.

1. The liquid supply device according to the embodiment is characterized in that the valve section has the diaphragm (114) for partitioning a part of the valve chamber (115), and is the differential pressure regulating valve which is opened and closed by deforming the diaphragm on the basis of a difference in pressure on both sides partitioned by the diaphragm so that the diaphragm comes into contact with or separates from the valve seat (103).

2. The liquid supply device according to the embodiment is characterized in that the buffer chamber (32) is configured so that a pressure of the liquid in the chamber is maintained to be higher than the liquid supply pressure applied to the liquid ejecting head even when an amount of the liquid in the chamber decreases in the process of the suction drive of the pump. According to this configuration, since the pressure of the liquid in the chamber is maintained to be higher than the pressure of the liquid (the liquid supply pressure) to be applied to the liquid ejecting head even when the amount of the liquid stored in the buffer chamber decreases, it is possible to supply the liquid from the buffer chamber to the liquid ejecting head at the required supply pressure.

3. The liquid supply device according to the embodiment is characterized in that the liquid replenishing mechanism is the spring type differential pressure regulating valve in which the valve plug is urged by a spring and which is opened to replenish the amount of the liquid consumed by the ejection from the ejection port.

4. The liquid supply device according to the embodiment is characterized in that the spring type differential pressure regulating valve, in which the valve plug is urged by a spring and which is opened to replenish the amount of the liquid consumed by the ejection from the ejection port, is provided in the path of the liquid supply flow channel on the downstream side of the buffer chamber.

5. The liquid supply device according to the embodiment is characterized in that the cleaning section is operated in a non drive state or the suction drive state of the pump so as to apply the suction force to the ejection port, the valve section is closed by the suction force so as to maintain the suction force in the valve-closed state, and the cleaning section starts the discharge drive of the pump at a set timing when the negative pressure within the downstream area of the valve section can be considered to be sufficiently high.

6. The liquid supply device according to the embodiment is characterized in that the cleaning section includes the cap (26) capable of coming into contact with the ejection port formation surface (18a), on which the ejection port is open on the liquid ejecting head unit, so as to enclose the ejection port, and a suction section (35) capable of applying the suction force to the inside of the cap. The liquid supply device is also characterized in that a liquid discharge amount dischargeable for a single discharge drive of the pump is larger than a total volume of a volume of the cap and a volume of the flow channel from a valve-closed position of the valve section to the ejection port.

What is claimed is:

1. A liquid supply device provided in a liquid ejecting apparatus which includes a liquid ejecting head having an ejection port for ejecting liquid and a cleaning section for compulsorily discharging the liquid from the ejection port by applying a suction force to the ejecting port of the liquid ejecting head, the liquid supply device supplying the liquid from a liquid supply source to the liquid ejecting head, the liquid supply device comprising:
a liquid supply section that has a pump provided in the path of a liquid supply flow channel for interconnecting the liquid supply source and the liquid ejecting head and a pair of unidirectional valves provided on an upstream side and a downstream side of the pump, and supplies the liquid to the downstream side by performing a suction drive for allowing the pump to suction the liquid from the liquid supply source and a discharge drive for discharging the suctioned liquid;
a liquid ejecting head unit that communicates with the liquid supply section through the liquid supply flow channel and has the liquid ejecting head; and
a valve section that is provided in the path of the liquid supply flow channel on the downstream side of the pump of the liquid supply flow channel, is maintained in a valve-closed state by the suction force applied to the ejection port, and is opened by a liquid supply pressure generated by the discharge drive of the pump in the valve-closed state,
wherein the valve section is provided in the liquid ejecting head unit.

2. The liquid supply device according to claim 1, wherein the valve section has a diaphragm for partitioning a part of a valve chamber, and the diaphragm is a non-spring type differential pressure regulating valve which is not urged by a spring.

3. The liquid supply device according to claim 1, wherein the liquid ejecting head is cleaned in a way that the cleaning section is operated in a non drive state or in the suction drive state of the pump so as to apply the suction force to the ejection port thereby creating a negative pressure in the downstream area of a valve-closed position of the valve section, and the liquid supply section starts the discharge drive of the pump at a set timing when the negative pressure within the downstream area of the valve section can be considered to be sufficiently high.

4. The liquid supply device according to claim 1, wherein the cleaning section includes a cap capable of coming into contact with the ejection port formation surface, on which the ejection port is open on the liquid ejecting head, so as to enclose the ejection port, and a suction section capable of applying the suction force to the inside of the cap, and
wherein a liquid discharge amount dischargeable for a single discharge drive of the pump is larger than a total volume of a volume of the cap and a volume of the flow channel from a valve-closed position of the valve section to the ejection port.

5. The liquid supply device according to claim 1, wherein a buffer chamber is provided in the path of the liquid supply flow channel between the valve section and the ejection port in the liquid ejecting head unit so as to store the liquid, which is to be supplied to the liquid ejecting head in the process of the suction drive of the pump, in the process of the discharge drive of the pump.

6. The liquid supply device according to claim 1, wherein a liquid replenishing mechanism is provided in the path of the liquid supply flow channel between the valve section and the ejection port in the liquid ejecting head unit so as to replenish the liquid ejecting head with an amount of the liquid, which corresponds to an amount of the liquid consumed by the ejection from the ejection port, by depressurizing the liquid to a supply pressure required for the liquid ejecting head.

7. The liquid supply device according to claim 6, wherein the liquid ejecting head unit includes the valve section, a buffer chamber, and the liquid replenishing mechanism, in that order from the upstream side of the liquid supply flow channel.

8. A liquid ejecting apparatus comprising:
the liquid supply device according to claim 1;
a liquid ejecting head for ejecting liquid, which is supplied from the liquid supply device, from an ejection port; and
a cleaning section for compulsorily discharging the liquid from the ejection port by applying a negative pressure to the ejecting port.

9. A liquid supply device provided in a liquid ejecting apparatus which includes a liquid ejecting head having an ejection port for ejecting liquid and a cleaning section for compulsorily discharging the liquid from the ejection port by applying a suction force to the ejecting port of the liquid ejecting head, the liquid supply device supplying the liquid from a liquid supply source to the liquid ejecting head, the liquid supply device comprising:
a liquid supply section that has a pump provided in the path of a liquid supply flow channel for interconnecting the liquid supply source and the liquid ejecting head, a first unidirectional valve provided on an upstream side of the pump, and a second unidirectional valve provided on a downstream side of the pump, and supplies the liquid to the downstream side by performing a suction drive for allowing the pump to suction the liquid from the liquid supply source and a discharge drive for discharging the suctioned liquid;
a valve section that is provided in the path of the liquid supply flow channel on the downstream side of the pump of the liquid supply flow channel, is maintained in a valve-closed state by the suction force applied to the ejection port, and is opened by a liquid supply pressure generated by the discharge drive of the pump in the valve-closed state; and
a buffer chamber that is provided in the path of the liquid supply flow channel on the downstream side of the valve section and stores the liquid.

10. The liquid supply device according to claim 9, further comprising a liquid ejecting head unit that communicates with the liquid supply source or the liquid supply section through a pipe line which is a part of the liquid supply flow channel, and has the liquid ejecting head, wherein the buffer chamber is provided in the liquid ejecting head unit.

11. The liquid supply device according to claim 10, wherein the valve section is provided in the liquid ejecting head unit.

12. The liquid supply device according to claim 9,
wherein the liquid is stored in the buffer chamber in the process of the discharge drive of the pump, and an amount of the liquid, which corresponds to an amount of the liquid consumed by the liquid ejecting head in the process of the suction drive of the pump, is supplied from the buffer chamber to the liquid ejecting head, and
wherein the buffer chamber is configured so that the pressure of the liquid in the chamber is maintained to be higher than the liquid supply pressure applied to the liquid ejecting head even when an amount of the liquid in the chamber decreases in the process of the suction drive of the pump.

13. The liquid supply device according to claim 12, wherein the buffer chamber has a flexible member for partitioning at least a part of a liquid storage chamber which stores the liquid, and the flexible member is a non-depressurization type which is not urged by a spring in a direction of depressurizing the liquid in the liquid storage chamber.

14. The liquid supply device according to claim 9, wherein the valve section has a diaphragm for partitioning a part of a valve chamber, and is a differential pressure regulating valve which is opened and closed by deforming the diaphragm on the basis of pressure difference of both sides with an interval therebetween so that the diaphragm comes into contact with or separates from a valve seat.

15. The liquid supply device according to claim 9, wherein a liquid replenishing mechanism is provided in the path of the liquid supply flow channel on the downstream side of the buffer chamber so as to replenish the liquid ejecting head with an amount of the liquid, which corresponds to an amount of the liquid consumed by the ejection from the ejection port, by depressurizing the liquid to a supply pressure required for the liquid ejecting head.

16. A liquid ejecting apparatus comprising:
the liquid supply device according to claim 9;
a liquid ejecting head for ejecting liquid, which is supplied from the liquid supply device, from an ejection port; and
a cleaning section for compulsorily discharging the liquid from the ejection port by applying a negative pressure to the ejecting port.
